(19) United States
(12) Patent Application Publication
(10) Pub. No.: US 2020/0382618 A1
(43) Pub. Date: Dec. 3, 2020

(54) MULTI-STREAM CONTENT FOR COMMUNICATION SESSIONS

(71) Applicant: MICROSOFT TECHNOLOGY LICENSING, LLC, Redmond, WA (US)

(72) Inventors: Jason Thomas FAULKNER, Seattle, WA (US); Ashwin M. APPIAH, Seattle, WA (US); Joshua GEORGE, Redmond, WA (US)

(21) Appl. No.: 16/428,957

(22) Filed: May 31, 2019

(51) Int. Cl. H04L 29/08; H04L 29/06; G06F 3/0484

(52) U.S. Cl. CPC H04L 67/36; G06F 3/04842; H04L 65/4015; H04L 65/1086

(57) ABSTRACT

The techniques disclosed herein provide ways to manage events for communication sessions. Content data comprising a plurality of content items associated with a plurality of communication sessions may be received, and a primary stream comprising a plurality of time slots for the communication session may be generated for each session. Selected content items are inserted in the time slots for broadcast to user devices of the communication sessions. Secondary or suggestive streams are generated that contain candidate content items that are insertable into the primary streams. A user interface renders a graphical representation of the primary streams concurrently with a graphical representation of the secondary streams. In response to a user input, the primary streams are modified by inserting selected content items into selected time slots of the primary streams.

### BACKGROUND

Some computing systems provide collaborative environments that facilitate communication between two or more participants. A system providing a collaborative environment can allow participants to exchange live video, live audio, and other forms of data within a communication session. A collaborative environment can take on any suitable communication session format including but not limited to private chat sessions, multi-user editing sessions, group meetings, broadcasts, etc.

The optimization of user engagement and content management of such collaborative environments is essential for user productivity and efficient use of computing resources. When software applications do not optimize user engagement and content management, production loss and inefficiencies with respect to computing resources can be exacerbated when a collaborative environment involves a large number of participants.

There are a number of drawbacks with some existing systems, and in particular the promotion of engagement with multiple users who are engaged in a dynamic meeting environment. For example, the layouts of some graphical user interfaces (UIs) do not always display shared content in a manner that is easy to read or control. Some systems do not allow users to easily engage with more than one video stream, and some systems do not display the right content at the right time. Additionally, many systems do not allow for management and control of content in a complex collaboration environment. Such systems work against the general principle that proper timing of content and facilitating multiple levels of interaction are essential for the optimization of user engagement. In addition, having a less than optimal UI layouts can lead to other user interaction inefficiencies during the operation of an application.

Some existing systems provide tools for allowing users to manually modify user interaction with an application. However, such systems require users to perform a number of menu-driven tasks to arrange graphical user interfaces and select and insert content. A user can spend a considerable amount of time searching through available items to select the content that is relevant to a particular topic. Such systems then require users to manually generate a desired layout of selected graphical items. This can lead to extensive and unnecessary consumption of computing resources.

Existing systems that allow manual edits to user interaction models have other drawbacks. Most notably, although some systems allow users to arrange a UI layout, a user performing such tasks must be skilled at keeping up with multiple meeting activities and managing the consumption of content based on meeting context. More importantly, users also need the appropriate experience to make timely adjustments that are necessary to stimulate or invigorate user engagement. Missed or incorrect opportunities in directing live events work against the overall productivity of the participants and computing resources used in facilitating a collaborative environment.

### SUMMARY

The disclosed embodiments provide techniques for an administrator or moderator to curate a communication session that can dynamically spawn additional sessions to form a complex and hierarchical network of sessions. Such a network or set of sessions may be analogous, in one example, to a meeting or conference that generates a number of side meetings and breakout sessions. A system for curating such sessions may provide, to the administrator or moderator, visibility of contents that are live in each session and contents queued for display in each session.

In one embodiment, for each communication session, the system may provide the administrator or moderator with a “live” sequence (e.g., an “a-roll”) and one or more secondary or supporting sequences (e.g., “b-rolls”) so that the administrator or moderator can dynamically switch to suitable b-roll contents as desired. In some embodiments, the b-roll contents may be based upon a dynamic search of contents in the queue in the same session or other sessions that is relevant to the content in the a-roll. Additionally, the b-roll contents may be based on a search of external content. As used herein, a live sequence may be referred to as a primary sequence or a primary stream. A secondary sequence may be referred to as a secondary stream, supporting sequence, or a supporting stream.

In some embodiments, the system may provide the administrator or moderator with a “live” or active sequence and one or more supporting queues that include various content of potential interest that may be added to the live sequence. The queues may be rendered as previews in parallel and may include suggestive content. In one embodiment, live and supporting queues may be generated for each of the side sessions that are associated with a primary meeting. The content may be automatically or manually fed to the stream associated with a given meeting. A supporting queue or stream may provide content that is part of a “b-roll” for each meeting and thus may available for insertion into the live stream for the relevant session.

The techniques disclosed herein provide dynamic engagement and curation of sequence events for a plurality of communication sessions, where it may be beneficial to coordinate the curation of the sessions by a single moderator, for example in a conference setting. The system may further provide the administrator or moderator with information that enables efficient time and resource management with regard to managed communication sessions. The timelines may indicate individual timelines for each session, including prepopulated activities and durations and a live cursor indicating which content item is currently live. In addition to queues for each session, content queues may be provided that include suggestive content that can be moved into various primary and support streams.

In some embodiments, associations can be established between streams. The association may enable content between the streams to be available to one another, for streams to be merged, content from one stream to be suggested to the associated stream, and so on. In some embodiments, streams can spawn new streams when side sessions are initiated. For example, meeting participants may start a side session with different focus areas and activities. New streams corresponding to new sessions can be automatically detected and launched. Alternatively, new streams can be manually started by the administrator or moderator. Additionally, new streams can be suggested when the system detects new content being accessed or opened within an existing session.

In one embodiment, the system may enable simultaneous curation of multiple primary streams and multiple secondary/supportive streams or queues (e.g., multiple a-rolls and multiple b-rolls). The multiple primary streams may correspond to an active main session and active side sessions, multiple main sessions and multiple side sessions, multiple side sessions, or any other combination.

The disclosed system may provide a number of advantages over existing systems which require that streams be replaced with another stream. Existing systems, for example, do not allow for multiple streams to be queued and curated. The described techniques allow for multiple sessions and events to be curated into a cohesive experience, while maintaining control of respective timelines and managing content via suggestive queues. Multiple sessions and events may be curated without the need to leave any individual session or event.

In some embodiments, the disclosed system may generate interfaces and controls based on the user's role. The role may determine the types of information that may be rendered as well as the access and controls that are allowed. For example, an administrator or moderator may be allowed to curate all the streams with specific content for each associated session. Such a view can be referred to as a producer view, and the role may be referred to as a primary moderator role. A user with such a role may be allowed to view and control all streams and queues for all sessions.

In some embodiments, a participant role may be defined that allows for participation in one or more sessions. One or more participants may actively participate in a session, collaborate on work on content that is accessible to participants of the session, view content for the session, and so on. Participants may also suggest content for sharing with other participants in the same session or participants in another session. When content is suggested, the instructor for the associated session may insert the suggested content into the queue for that session.

In some embodiments, a user may be able to access multiple streams on the user's device, enabling the user to follow multiple sessions. Additionally, users may communicate with other users in the same session or different sessions using a variety of communications functions such as messaging, chat, and live video or audio.

In some embodiments, new sessions may be generated based on user instructions or based on context. For example, when two or more participants begin collaboration on the same document, the system may recognize the collaboration and suggest an option to start a side session, which may include a new chat session or other type of engagement. In another example, two or more participants may initiate the start of a new session by using controls provided by the session interface that enable efficient launching of the new session. The session interface may allow, for example, selection of one or more active documents or other content to form the initial or seed content for the new session. Notification of the new session may be provided to the main moderator as well as the new instructor for the new session so that the active stream and content queue for the new session may be monitored and curated.

The techniques disclosed herein provide a number of features that improve existing computers. For instance, computing resources such as processor cycles, memory, network bandwidth, and power, are used more efficiently as a system can transition between different interaction models without user input. In addition, the techniques disclosed herein improve security of the system. By dynamically changing permissions to data access and editing capabilities, a system can accommodate different needs based on the presence of specific user scenarios. The techniques disclosed herein also improve user interaction with various types of computing devices. Improvement of user interaction can lead to the reduction of user input, which can mitigate inadvertent inputs, redundant inputs, and other types of user interactions that utilize computing resources. Other technical benefits not specifically mentioned herein can also be realized through implementations of the disclosed subject matter.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A illustrates an example scenario involving a system for generating sequence events for a timeline of a collaborative environment.

FIG. 1B illustrates an example scenario involving a system for generating sequence events for a timeline of a collaborative environment.

FIG. 1C illustrates an example scenario involving a system for generating sequence events for a timeline of a collaborative environment.

FIG. 2 is a diagram illustrating an example scenario where various types of data can be used to generate a sequence events for a timeline.

FIG. 3A is a diagram illustrating an example interface for curating multiple sessions.

FIG. 3B is a diagram illustrating an example interface for curating multiple sessions.

FIG. 3C is a diagram illustrating an example interface for curating multiple sessions.

FIG. 3D is a diagram illustrating an example interface for curating multiple sessions.

FIG. 4 is a diagram illustrating an example interface for curating multiple sessions.

FIG. 5 illustrates a communication session.

FIG. 6 illustrates multiple communication sessions.

FIG. 7 illustrates multiple communication sessions.

FIG. 8 illustrates multiple communication sessions.

FIG. 9A illustrates an example interface for a communication session.

FIG. 9B illustrates an example interface for a communication session.

FIG. 9C illustrates an example interface for a communication session.

FIG. 9D illustrates an example interface for a communication session.

FIG. 9E illustrates an example interface for a communication session.

FIG. 9F illustrates an example interface for a communication session.

FIG. 10 is a flow diagram illustrating aspects of a sample routine for implementing the techniques disclosed herein.

FIG. 11 is a flow diagram illustrating aspects of a sample routine for implementing the techniques disclosed herein.

FIG. 12 is a flow diagram illustrating aspects of a sample routine for implementing the techniques disclosed herein.

FIG. 13 is a flow diagram illustrating aspects of a sample routine for implementing the techniques disclosed herein.

FIG. 14 is a computing system diagram showing aspects of an illustrative operating environment for the techniques disclosed herein.

FIG. 15 is a computing architecture diagram showing aspects of the configuration and operation of a computing device that can implement aspects of the techniques disclosed herein.

### DETAILED DESCRIPTION

The disclosed embodiments provide techniques for an administrator or moderator to curate a communication session that can dynamically spawn additional sessions to form a complex and hierarchical network of sessions. Such a network or set of sessions may be analogous, in one example, to a meeting or conference that generates a number of side meetings and breakout sessions. A system for curating such sessions may provide, to the administrator or moderator, visibility of contents that are live in each session and contents queued for display in each session.

In one embodiment, for each communication session, the system may provide the administrator or moderator with a “live” sequence (e.g., a-roll) and one or more secondary or supporting sequences (e.g., b-roll) so that the administrator or moderator can dynamically switch to suitable b-roll contents as desired. In some embodiments, the B-Roll contents may be based upon a dynamic search of contents in the queue in the same session or other sessions that is relevant to the content in the a-roll. Additionally, the b-roll contents may be based on a search of external content. Content, as used herein, may refer to any form of information from any source, including audio, video, images, files, and the like. As used herein, an “a-roll” may refer to primary media content (e.g., audio and video) that may depict the primary speaker, topic, or narrative for a given session. A “b-roll” may refer to supplemental media that may be used in a variety of ways, for example to support or complement the a-roll or for use as a cutaway to allow the moderator to make changes to the a-roll. The system may provide the administrator or moderator various ways to mix a-roll and b-roll media to efficiently provide a productive communication session experience for the users.

The examples described herein are provided in the context of collaborative environments, e.g., private chat sessions, multi-user editing sessions, group meetings, live broadcasts, etc. For illustrative purposes, it can be appreciated that a computer managing a collaborative environment involves any type of computer managing a communication session where two or more computers are sharing data. For illustrative purposes, an “event” may be a particular instance of a communication session, which may have a start time, an end time, and other parameters for controlling how data is shared and displayed to users participating in the communication session.

In some embodiments, the system may provide the administrator or moderator with a “live” or active sequence and one or more supporting queues that include various content of potential interest that may be added to the live sequence. The queues may be rendered as previews in parallel and may include suggestive content. In one embodiment, live and supporting queues may be generated for each of a plurality of sessions. As used herein, a live queue may be referred to as a live track, live stream, or primary stream. For example, a live queue may provide content that is part of an “a-roll” for each communication session and thus may feed into the primary stream for the communication session. The content may be automatically or manually fed to the applicable stream. In some embodiments, the stream may be toggled between an automatic feed and a manual feed. A supporting/secondary queue or stream may provide content that is part of a “b-roll” for each communication session and thus may available for insertion into the primary stream for the relevant session. Content may be automatically or manually inserted into the supporting/secondary queue.

The queues may be automatically populated. In a fully automatic mode, content for each queue may be populated based information such as on one or more patterns that are detected for each session. Additionally, the administrator or moderator may insert tags that indicate topics or key words of interest for each session. Patterns or tags may be determined based on meeting speakers/moderators, meeting content, meeting activity, timing, and other factors.

The techniques disclosed herein thus provide dynamic engagement and curation of sequence events for a plurality of communication sessions, where it may be beneficial to coordinate the curation of the sessions by a single moderator, for example in a conference setting. The disclosed system can utilize smart filtering techniques to generate, modify, arrange, and select sequence events that are designed to optimize user engagement. The system may, for example, collect contextual data associated with each of a plurality of communication sessions, which can be in the form of a private chat session, a multi-user editing session, a group meeting, a live broadcast, etc. The system can utilize the contextual data and other input data defining user activity to customize sequence events defining contextually-relevant user interface (UI) content, modality, and other parameters controlling aspects of the communication sessions. The system can apply the sequence events to specific points in a timeline that provides a visual representation of interaction models that are used to control and display aspects of the communication sessions.

The system may further provide the administrator or moderator with information that enables efficient time and resource management for a complex arrangement of sessions. Content may be tagged automatically or manually for primary streams for the main and/or side sessions. The timelines may indicate individual timelines for each session, including prepopulated activities and durations and a live cursor indicating which content item is currently live. In addition to queues for each session, content queues may be provided that include suggestive content that can be moved into various primary and support streams.

The live/primary streams may run continuously in an automatic mode and can be interrupted and modified at any time by the administrator or moderator. The various queues may be configured to allow for queue previews, queue timelines, live timelines, and live previews.

The system may operate in an automated mode and apply the sequence events to specific points in a timeline without user input. The system may also operate in a manual mode and display recommended sequence events to a user for providing immediate access to live or ongoing editing opportunities. The system may select the automated mode, the manual mode, or combination of the modes based on a number of factors including the availability of resources and the detection of specific user scenarios. While in the automated mode, the sequence events can improve user engagement of a communication session even when a user is not available to manually edit aspects of the communication session. However, while in manual mode, the system can display suggestions of contextually relevant sequence events to assist a user in making timely and effective modifications to aspects of a communication session.

In some embodiments, associations can be established between streams. The association may enable content between the streams to be available to one another, for streams to be merged, content from one stream to be suggested to the associated stream, and so on.

In some embodiments, streams can spawn new streams when side sessions are initiated. For example, meeting participants may start a side session with different focus areas and activities. New streams corresponding to new sessions can be automatically detected and launched. Alternatively, new streams can be manually started by the administrator or moderator. Additionally, new streams can be suggested when the system detects new content being accessed or opened within an existing session. New streams may inherit the permissions, data, and settings of the main session or the parent session.

The disclosed system may provide a number of advantages over existing systems which require that streams be replaced with another stream. Existing systems, for example, do not allow for multiple streams to be queued and curated.

In one embodiment, the system may enable simultaneous curation of multiple primary streams and multiple secondary streams or queues (e.g., multiple a-rolls and multiple b-rolls). The multiple active streams may correspond to an active main session and active side sessions, multiple main sessions and multiple side sessions, multiple side sessions, or any other combination.

Each active/primary stream may have a content queue that may be populated via a search that may be executed by the system. The search may be performed automatically based on the context of each session. The content may include documents, video files, audio files, contacts, and the like. The system may be configured to allow the administrator or moderator to enter filters that may further inform the search.

In some embodiments, the system may generate interfaces and controls based on the user's role. The role may determine the types of information that may be rendered as well as the access and controls that are allowed. For example, an administrator or moderator may be allowed to curate all the streams with specific content for each associated session. Such a view can be referred to as a producer view, and the role may be referred to as a primary moderator role. A user with such a role may be allowed to view and control all streams and queues for all sessions.

A teacher or presenter role may be defined that is allowed to view and control streams and queues for sessions that are associated with a specified teacher or presenter. In some embodiments, the primary administrator or moderator role may be allowed to receive or access all incoming content and send content to any selected session that may also be controlled by respective teacher or presenter roles. In an embodiment, the primary administrator or moderator role may be allowed to send content to teacher or presenter roles who may be receiving their own content for their respective sessions. The permissions and content associated for each role may be configurable, and may be structured so that the roles form a tiered or hierarchical set of relationships between the roles and their associated sessions. Additionally, each communication session may be associated with a privacy or permission level that is inherited by any moderator, teacher, or presenter role associated with that session. The privacy or permission level may be adjusted by the moderator or instructor roles and may also be automatically adjusted based on the current activity.

In some configurations, the system can dynamically control permissions for participants of a collaborative environment. The permissions may determine levels of access to specific content, editing capabilities, and access to devices that may be used to facilitate a communication session. The system can dynamically change permissions for each participant based on a number of factors, including the detection of specific user scenarios. This dynamic control of permissions based on attributes characterizing an event allows applications to automatically adjust security access to data and certain functionality to accommodate specific user scenarios, promote efficient use of computing resources, and improve the security of data.

The system may be configured to allow curation of content for live or virtual communication sessions that include a plurality of communications technologies such as computer-based applications, virtual and augmented reality, 2D and 3D rendering engines, and the like.

The system may allow multiple sessions to be accessed, either one at a time or in parallel. Additionally, each session may be associated with streams that can include multiple applications and content types, or multiple instances of the same application. For example, multiple presentations may be presented in a given session.

In some embodiments, a participant role may be defined that allows for participation in one or more sessions. One or more participants may actively participate in a session, collaborate on work on content that is accessible to participants of the session, view content for the session, and so on. Participants may also suggest content for sharing with other participants in the same session or participants in another session. When content is suggested, the instructor for the associated session may insert the suggested content into the queue for that session.

Participants associated with a particular session may have visibility to other sessions, or in some embodiments may not be allowed to have visibility to other sessions. Participants may move between the sessions on their own initiative, or in some embodiments may require approved by the moderator. In some embodiments, the moderator may move participants between sessions.

In some embodiments, a participant in a specific session may only see content queued for use/presentation in the specific session. Access privileges associated with each session may be inherited to each participant of that session.

In some embodiments, new sessions may be generated based on user instructions or based on context. For example, when two or more participants begin collaboration on the same document, the system may recognize the collaboration and suggest an option to start a side session, which may include a new chat session or other type of engagement. In another example, two or more participants may initiate the start of a new session by using controls provided by the session interface that enable efficient launching of the new session. The session interface may allow, for example, selection of one or more active documents or other content to form the initial or seed content for the new session. Notification of the new session may be provided to the main moderator as well as the new instructor for the new session so that the active stream and content queue for the new session may be monitored and curated.

In some embodiments, more than one moderator or instructor may be associated for a session, allowing for multiple users to curate content for a session. The system may implement a conflict resolution mechanism when incompatible instructions are provided by multiple moderators.

In some embodiments, a user may be able to access multiple streams on the user's device, enabling the user to follow multiple sessions. In some embodiments, users may communicate with other users in the same session or different sessions using a variety of communications functions such as messaging, chat, and live video or audio.

In some embodiments, the user interface for a session participant may allow for the participant to participate in a primary session and monitor the content of one or more secondary sessions. For example, the participant may render video and audio for the primary session, while monitoring (for example, in a separate window) another session using closed captioning or other forms of transcribing. This may be analogous to attending a meeting locally, while monitoring the progress of another meeting via the user's device. This may be useful for monitoring the progress of a meeting where the participant is scheduled to participate on an upcoming agenda item.

In various embodiments, the system may enable participants to engage in multiple session streams at different levels or types of modality, allowing the user to dynamically control levels of engagement and activity for each session. Modality may refer to the mode of engagement for a given session, such as transcript, audio, video, chat, and the like. The modality may be toggled, for example, for each active session in which a participant is engaged.

The system may also facilitate the termination of sessions. A given session may have generated one or more content items. When the session is terminated, the content may automatically be sent to queues of active sessions based on filters. The content may further be sent to the main moderator, who may select queues for sessions that may be interested in the content. The moderator may also archive the content.

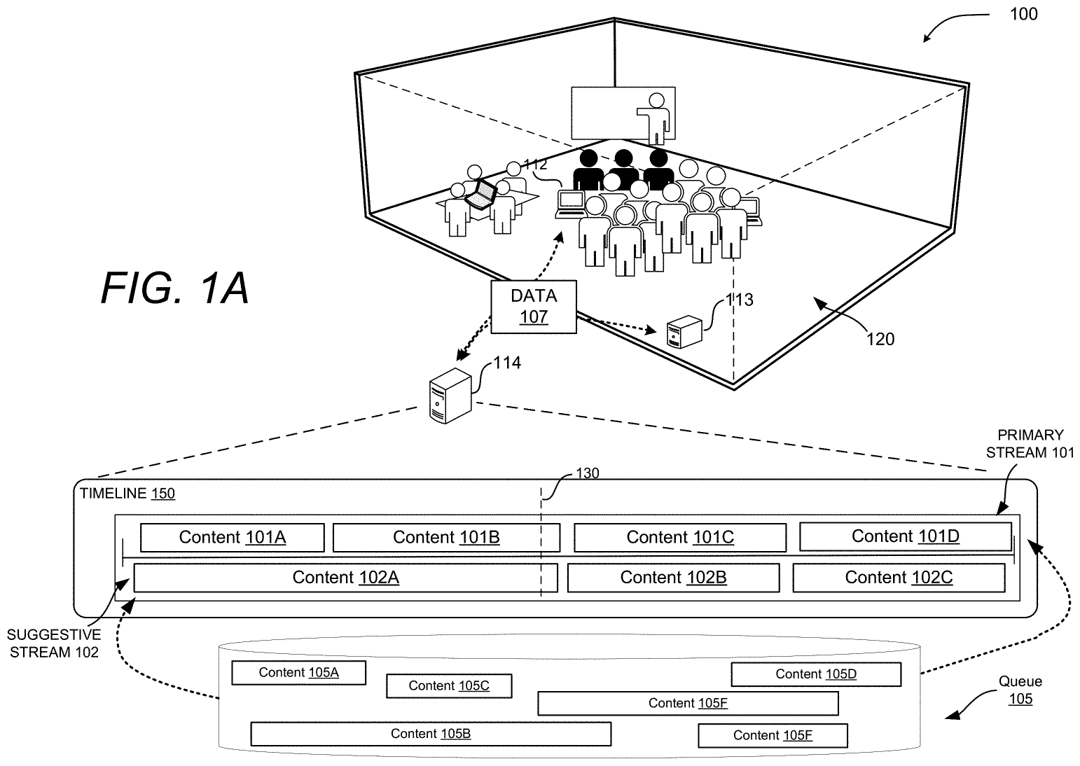

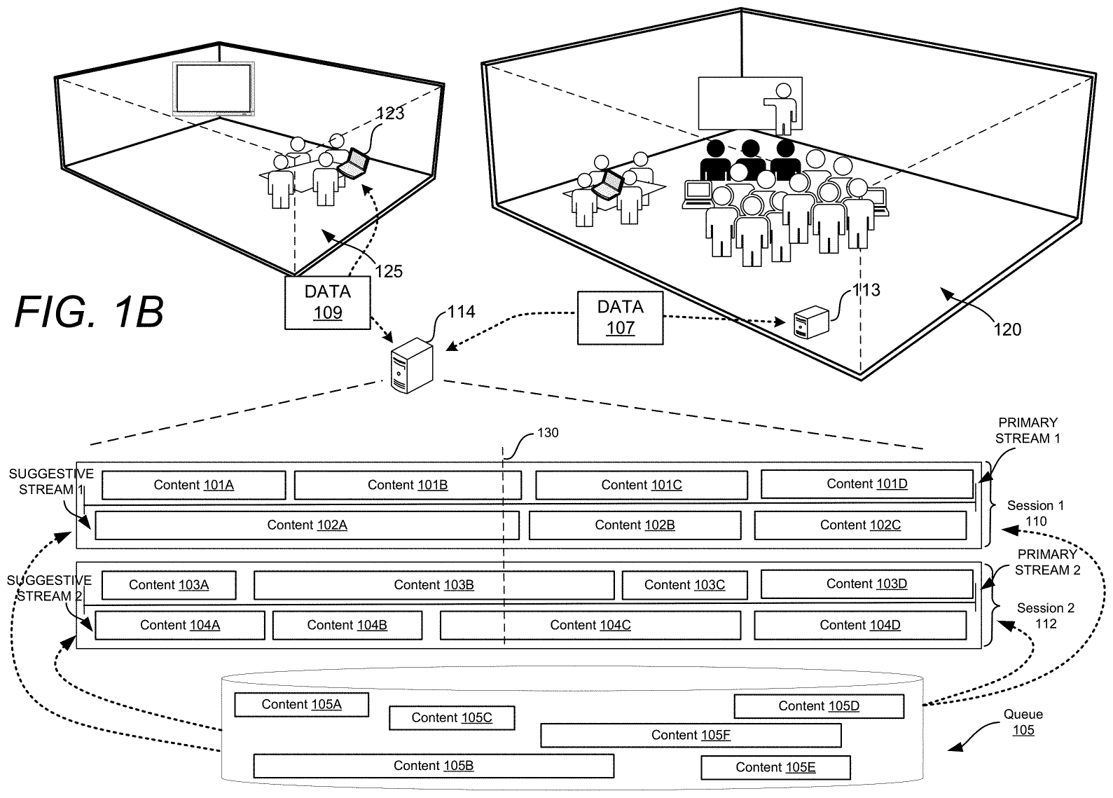

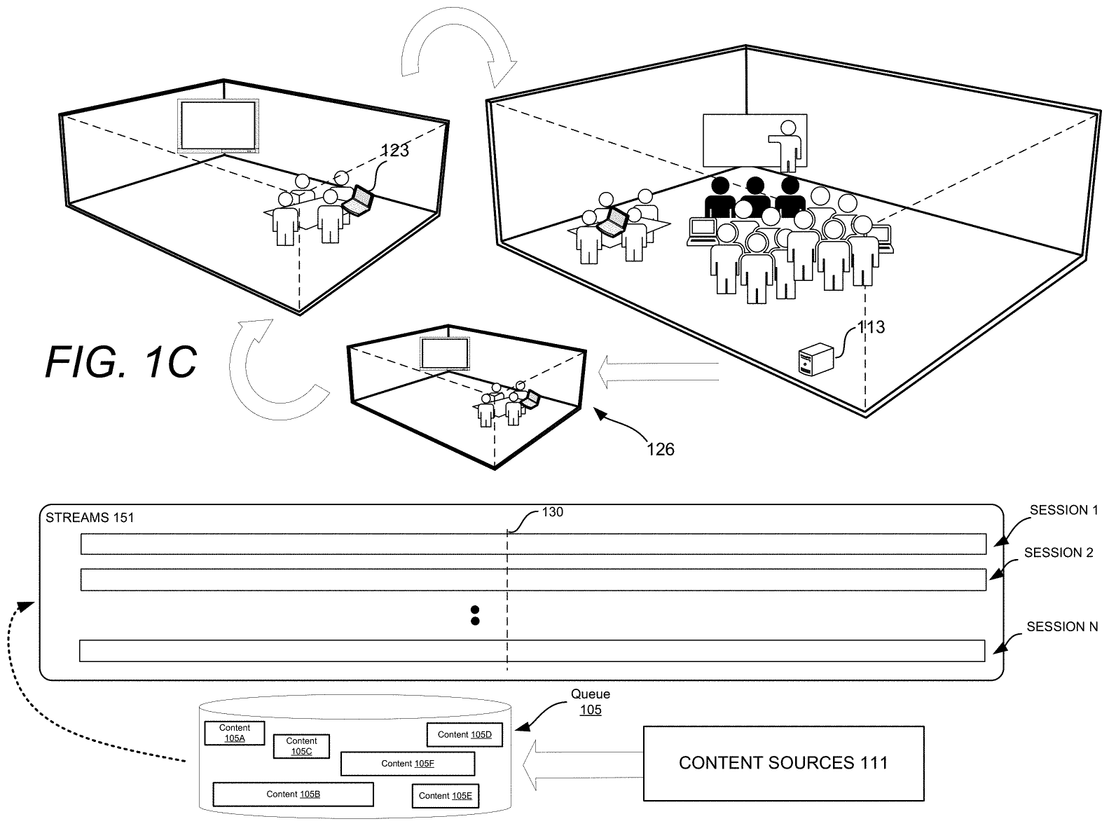

FIG. 1A illustrates an example scenario involving a system 100 for providing dynamic curation of a timeline 150 for a communication session. The system 100 can allow a moderator or administrator to generate, modify, arrange, and select content for time slots or sequence events for timeline 150. The configuration of the timeline 150 as implemented by time slots or sequence events and the arrangement of a number of time slots or sequence events within such a timeline can be designed to increase user engagement and productivity.

In an embodiment, timeline 150 can comprise a primary stream 101 and a suggestive/secondary stream 102. Primary stream 101 can include content items 101A, 101B, 101C, and 101D. Suggestive/secondary stream 102 can include content items 102A, 102B, 102C, and 102D. Queue 105 can include content items 105A, 105B, 105C, 105D, 105E, and 105F. The system can receive data 107 from various user devices 112, 113 that are associated with a communication session 120. Aspects of the functionality associated with the dynamic curation may be implemented on one or more computing devices 114. The timeline 150 and at least portions thereof may be rendered on a user interface, for example on a display device that is communicatively coupled to computing device 114. An indication 130 may indicate a current point in time.

The content data 101, 102, and 105, also referred to herein as “content” or “content items,” can comprise any image, document, video data, audio data, or any other information that can be used as presentation or collaboration materials. The content data 101 and 102 can also include other forms of data such as meeting requests, which can identify a number of attendees, titles associated with each attendee, and other related information. The content data 101 and 102 can also indicate parameters for an event, such as a start time, end time, and a location. For example, the content data 101 and 102 can include a meeting request indicating a list of attendees, the roles of each attendee, a date, a time, and a location.

FIG. 1B illustrates that an additional communication session 125 is now included, which is providing data 109 to the computing device 114 that generates and manages timeline 150. Timeline 150 includes session 1 110 that includes a primary stream and suggestive/secondary stream that includes content data 101 and 102. Timeline 150 also includes session 2 112 that includes a primary stream and suggestive/secondary stream that includes content data 103 and 104.

FIG. 1C illustrates another example in which a new session 126 has been added. Streams view 151 includes streams for session 1, session 2, and so on through session N. Each session stream may in turn include a primary stream and a suggestive stream. Timeline 150 also includes queue 108 that may receive content from a content source 111. The suggestive/secondary stream may correspond to a b-roll that includes optional content that are placed in a suggested curated timeline and may be fed from a queue. The contents items from the suggestive/secondary stream may be inserted into the primary stream and vice versa. Content items may also be directly inserted into the primary stream from queue 108. In some cases, the primary stream may be replaced by the selected content item starting at a selected time slot.

The sessions may represent locations of live activity influenced by a number of factors. For example, attendees that are connected to the various events may also contribute content. Each session may be can interjected either directly or with b-roll suggestive content to influence the live content. In some embodiments, the individual streaming events may be merged so that events can be co-curated into a single event with suggested content. In some embodiments, the moderator or attendee can maintain a top-level combined view or optionally enter or reenter one of the activities.

The queue and other sources may provide a source of content that can be placed into a suggested timeline, automatically or via user selection. Curation into a timeline may include formatting and other editing features to enable curation of the content into respective streams.

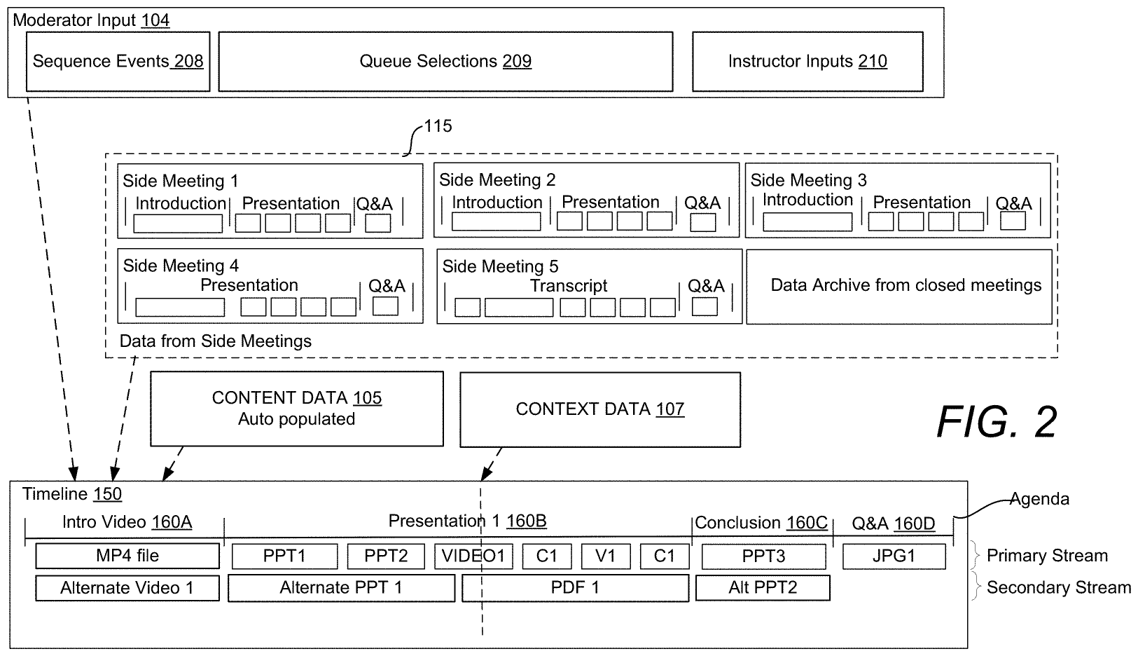

FIG. 2 illustrates an example where timeline 150 can be configured by the use of moderator input 104, side meeting data 115, content data 105, and context data 107. Moderator input 104 can include sequence events 208, queue selections 209, and instructor inputs 210. Side meeting data 115 can include data from various side meetings as well as archived data from previously closed meetings. Content data 105 may be automatically populated in this example, but in some embodiments may be populated manually. One or more of the elements in FIG. 2 may be rendered on a user interface that may be used by a moderator or administrator for curation of the timeline 150 and associated communication sessions.

In some configurations, the system 100 can analyze content and dynamically change aspects of a timeline based on content that meets one or more criteria. For instance, when content indicates a particular user scenario, the system 100 can modify a sequence event, add a new sequence event, or rearrange the order of established sequence events based on an analysis of shared content. In some configurations, the order of the sequence events can be based on a placement parameter. For instance, a placement parameter can indicate that a first sequence event is positioned in front of a second sequence event. In another example, a placement parameter can indicate specific times at which a sequence event starts and ends.

For illustrative purposes, consider a scenario where a user modifies the agenda for a meeting. In addition to a presentation by the conference speaker, the modification includes a second presentation by a second speaker. In this example, the presentation may also identify the second speaker. Using the identity of the new speaker, the system 100 may search for and retrieve the second speaker's presentation.

In response to identifying the new presenter and retrieving the presenter's content, a new presentation section can be added to the timeline 150. With reference to the example of FIG. 2, a second presentation section “Alternate PPT” may be added to the timeline 150 into the primary stream. In addition, corresponding sequence events can be added to the timeline.

In another example, consider a scenario where the system 100 analyzes the transcripts of two speaking engagements. When the system 100 identifies a section of content making reference to supporting content, the system can insert that content into the suggestive stream. The search for content can be analyzed using techniques, including machine learning techniques, for understanding keywords and phrases that are relevant to a particular audience. In response to identifying new content, the system takes one or more actions for modifying at least a suggestive stream configured to improve user engagement.

In one example, the system may determine that a content item in the primary stream starts at time X and ends at time Y. In response to determining that at least one additional content item is relevant to the content item in the primary stream, the system can insert the additional content into the relevant time slot.

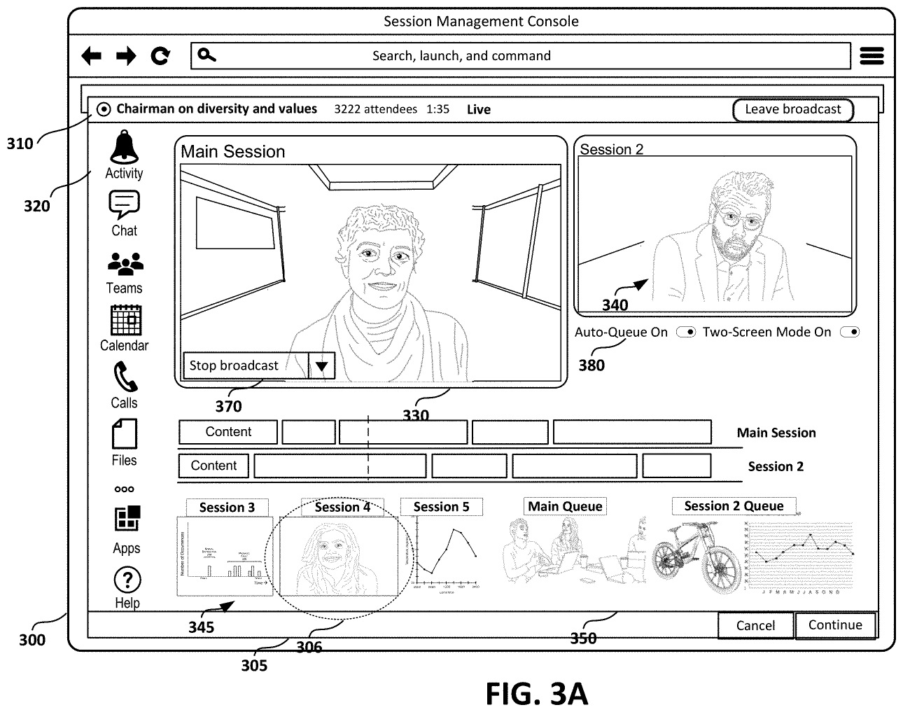

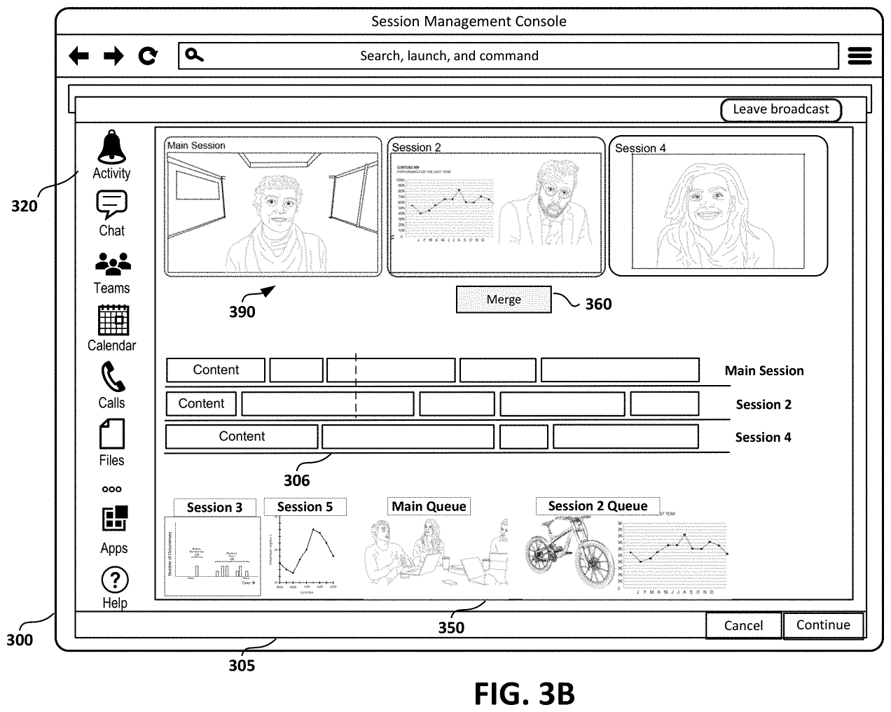

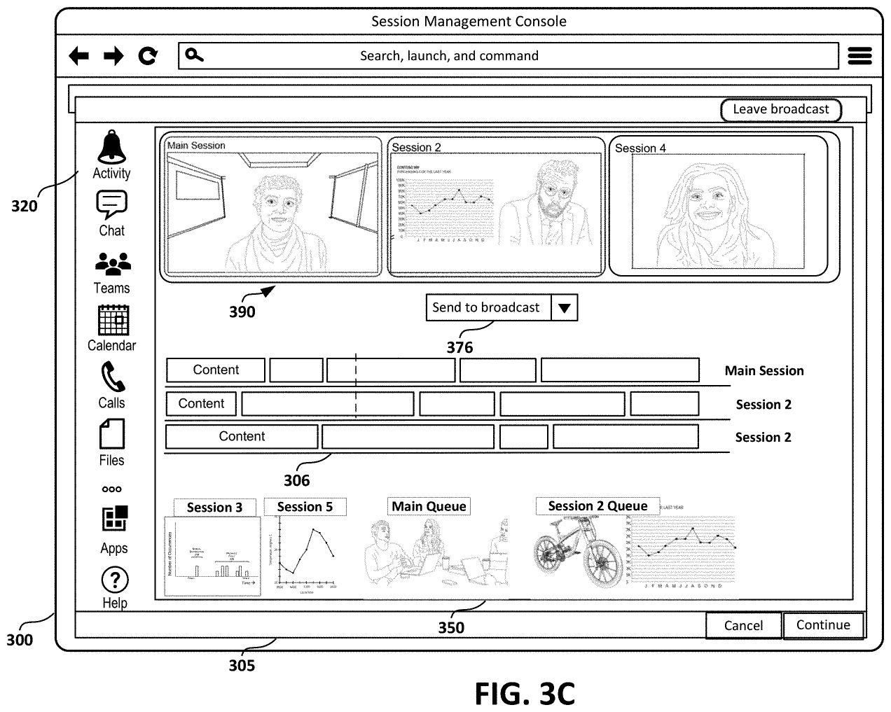

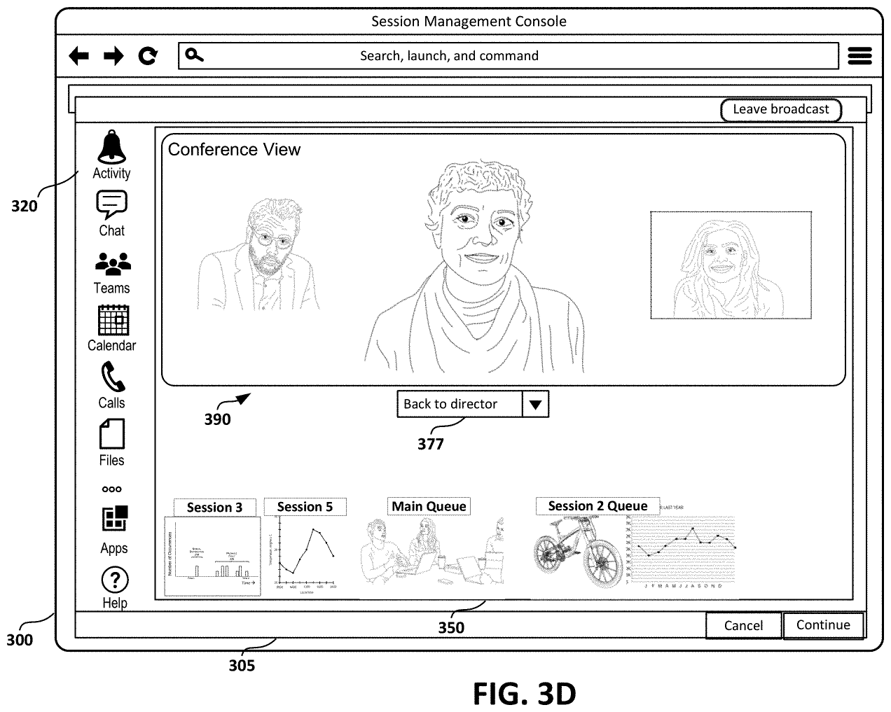

In some embodiments, the content data in the primary and suggestive streams and the timeline 150 can be displayed on a user interface. In one embodiment, FIG. 3A illustrates an example interface 300 that illustrates some of the features described herein. The user interface 300 can display a graphical element 305 to identify a main broadcast 330, a second session 340, additional sessions 345, and queued content items 355 for the main session and queued content items for session 2. Suggested content items from the queues may be inserted by selecting one of the queue items and activating user controls.

FIG. 3A further illustrates that a user may select 306 a session for further curation and/or merging with sessions 330 and 340. FIG. 3B illustrates that session 4 has been rendered alongside the main and side sessions. Timeline 306 has been updated to include the newly selected session, and a user control 360 may be provided to merge the selected sessions. FIG. 3C illustrates that a merged view 390 has been created based on the main session, session 2, and session 4. A further user control 376 is provided to broadcast the merged sessions. FIG. 3D illustrates the conference view 390 that has been generated based on the merged sessions. A further user control 377 may be provided to return to the director views shown in FIG. 3A, FIG. 3B, or FIG. 3C, for further curation possibilities.

As summarized above, the system in automated mode can adjust sequence events or change the order of sequence events based on user activity. Alternatively, the system can allow the moderator or administrator to make adjustments manually. In some embodiments, the system 100 can detect levels and types of engagement with respect to a user that is engaged in a communication session. For example, the system may track a user's consumption of broadcast content or interaction with a content item and determine a level of engagement based on a selected modality, a pattern of editing, or a particular gesture, such as a user adjusting a zoom level. In another example, the system can determine when audience members are engaging in a particular activity, e.g., editing a shared document. Such actions can be captured by the system, monitoring the activities of an audience.

A threshold level of engagement can be identified when users are taking notes or when a predetermined pattern of engagement is detected. A threshold level of engagement can be identified when a user stops taking notes, starts taking notes, when a user sends a chat message, or when a user opens a particular document that is associated with a communication session. A threshold level of engagement can be identified when the user performs an input action or opens/closes a document. A threshold level of engagement can be identified, for example, when maintains a chat session with another user for a predetermined period of time. Such activities can apply to categories of users. For instance, a threshold level of engagement can be identified when two or more users collectively performs an action, but the threshold level of engagement is not identified when individuals perform that specific action.

In response to identifying a threshold level of engagement, a system may take one or more actions, e.g., suggest a new meeting or side session, close a meeting, etc. The system can also re-order the sequence events within a timeline to based on content or user engagement at desired times.

In one example, consider a scenario where the system detects a threshold level of engagement during a presentation. For example, the system detected that a presentation ended earlier than scheduled. In response to such a scenario, the system can rearrange the order of content in a secondary stream to align the suggested content with the adjusted timeline. The system can generate an updated timeline to indicate this change.

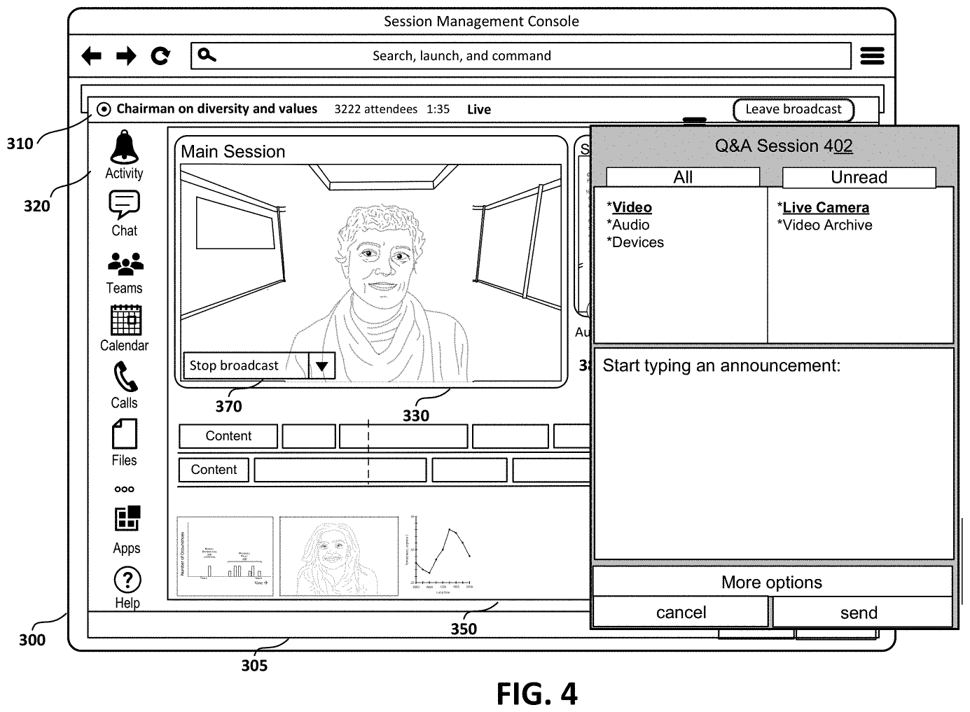

As summarized above, instead of making automatic adjustments to a timeline, the system 100 can operate in manual mode and generate suggestions for making adjustments to the sequence events. Additionally, the system can allow the user to interact with one or more broadcast sessions. FIG. 4 illustrates one example of a pane 402 that can be displayed to a user for providing immediate access to live or ongoing editing and interactive opportunities. In this example, in response to detecting the presence of a predetermined condition, such as a threshold level of engagement and/or a threshold change in the timeline, the system can display a graphical element, an annotation, or generate any form of output to allow for the user to insert a change with respect to a sequence event. A suggestion can be in the form of a graphical element, a computer-generated voice, or any visual indicator. As shown in FIG. 4, in pane 402, a user can access content, generate an announcement, or approve a suggestion to produce an updated timeline.

As summarized above, the system can dynamically control permissions for participants of a collaborative environment. Permissions can control access to specific content, editing capabilities, and access to one or more hardware devices. The system can dynamically change permissions for each participant based on a number of factors, including the presence of specific user scenarios. For instance, if an event includes a number of users each having specific permissions to edit the content of a collaborative environment, those permissions may be strictly enforced or relaxed based on the number of participants. Thus, in an event that is characterized as a broadcast, e.g., an event having one presenter and several thousand attendees, permissions that restrict audience members from editing a communication session may be strictly enforced. However, in an event that is characterized as a meeting, e.g., an event having five attendees, permissions that restrict the attendees from editing a session may be relaxed. This dynamic control of permissions based on attributes characterizing an event allows applications to automatically adjust the security access to data and certain functionality to accommodate specific user scenarios. This dynamic control of permissions can also improve the overall security of the system, devices of the system, and content data.

It can be appreciated that the permissions can change over time. For instance, when it comes to the shared content, the audience members have read-only permissions up to the conclusion of the presentation. During certain segments, the audience members may have the ability to add annotations to the content. In addition, during some interactive sessions, the audience members may be allowed to provide audio input.

The permissions can also be modified by the system in response to the identification of one or more conditions. For instance, the system may monitor conversations within an audience. The system may also determine when members of the audience have predetermined expressions, e.g., ask specific questions relating to a topic, express a concern, etc. In response to identifying the presence of a predetermined expression, the system may modify a sequence event.

For example, consider a scenario where a system 100 monitors the activity of an audience and the presenter. If it is determined that the presenter has concluded a speech ahead of schedule, the system may modify the timeline to allow the next content item to be broadcast earlier than scheduled. In another example, if the presenter indicates a need to modify content, the system may allow the moderator to adjust or replace the content, or allow the presenter to identify the content item for insertion in the primary stream. Such modifications can also be in response to a direct user input. For instance, if the moderator has read and write permissions for the timeline, the moderator can provide a manual input to change the content item. These examples are provided for illustrative purposes and are not be construed as limiting. Thus, it can be appreciated that any type of modification to any sequence event can be performed in response to the detection of a particular user scenario. In some embodiments, the system 100 can dynamically control permissions for individual users or roles associated with users based on the presence of specific user scenarios.

As summarized above, the system can operate in an automated mode and apply the sequence events to specific points in a timeline without user input. The system can also operate in a manual mode and display recommended sequence events to a user for providing immediate dynamic access to live or ongoing editing opportunities. The system may select the automated mode, the manual mode, or a combination of the modes based on a number of factors including the availability of resources and the presence of specific user scenarios. In one illustrative example, the system may select the automated mode, the manual mode, or combination of the modes based on a number of attendees, a number of presenters, a number of audience members, and/or a value indicating a title or rank of one or more attendees.

In the example shown in FIG. 3A, the user interface 300 comprises several display areas showing a live feed 330, additional live feed 340, and a queue of suggested content items 355. The user interface 300 also comprises input control elements for displaying the operating mode and for allowing user input to control the operating mode. The user interface 305 also comprises a control mechanism 370 for allowing a user to manually sending or stopping the timeline and/or the live communication feed 330. In some embodiments illustrated in FIG. 3A, additional windows 345 may be rendered that each provides live content being presented in a plurality of communication sessions. This allows the moderator to have visibility of content in any session.

With reference to the above-described example of the system operating in manual mode, when the system generates a suggestion for modifying the timeline, e.g., the system may generate a sequence event defining those modifications. The user interface 300 shows the suggested modifications in an interactive area 402 depicted in FIG. 4.

Also shown in FIG. 3A, the input control element 380 also indicates a selected operating mode. The user can interact with the input control element 380 to change the operating mode of the system. For instance, based on a user input at the control element 380, the system can transition from manual mode to automatic mode, transition from automatic mode to manual mode, or transition to a semiautomatic mode in response to a user interacting with the control element 380. Although this example shows the control element 380 as a slide bar, it can appreciated that the control element 380 can be in any form including a computer-generated voice indicating an operating mode, and an input can be a voice command. FIG. 3A shows that a moderator can select a session 306 for further curation.

FIG. 3B illustrates that after selection of session 4, a top view 390 of the various selected sessions. An option to merge 360 the selected sessions is illustrated. Timeline 306 is updated to show the respective timelines for each selected session. FIG. 3C illustrates that once the selected sessions have been merged, an option 376 may be provided to send the merged content to selected attendees. FIG. 3D illustrates a combined top-level view 390 showing the merged sessions.

As described above, the system can operate in different modes to accommodate different user scenarios. While in the automated mode, the sequence events can improve user engagement even when a user is not available to direct the parameters of a collaborative environment. Such configurations are beneficial for small meetings where a dedicated person is not available to direct the content. However, while in manual mode, the system can display suggestions of contextually-relevant sequence events to assist a user making timely and effective modifications to a collaborative environment. Such configurations are beneficial for large broadcasts and/or meetings where the availability of a person for directing the content is more likely.

The techniques disclosed herein can involve any type of modification to a sequence event, e.g., a modification to a timeline or a live communication feed. As described above, contextual data associated with an event can be analyzed to determine one or more modifications that can be made to a sequence event.

In some embodiments, system 100 may be configured to analyze the audio streams of the participants in a meeting. The system may be configured to identify phrases and references to specific content. In one example, the analysis may be used to search for content, determine a context of a meeting, determine whether a new meeting should be initiated, and so on.

In response to a user input, such as the activation of the control mechanism 360, the system may modify the live stream 330. In addition, the system may modify the contents of live stream 330 or 340. Specifically, the queue 350 may be used to generate a modified live stream 330 or 340. Additional live streams and queues may be rendered such as that depicted in FIGS. 1A-1C.

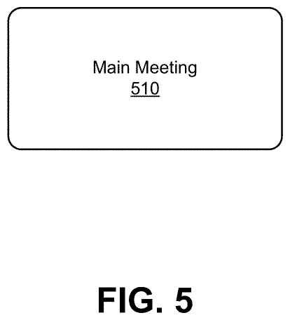

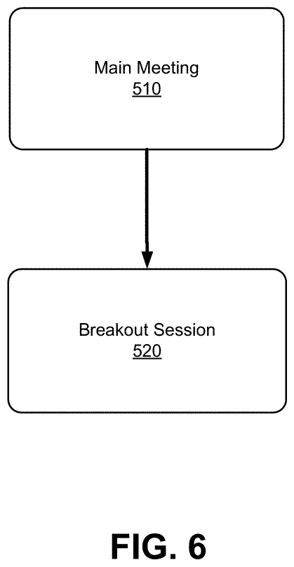

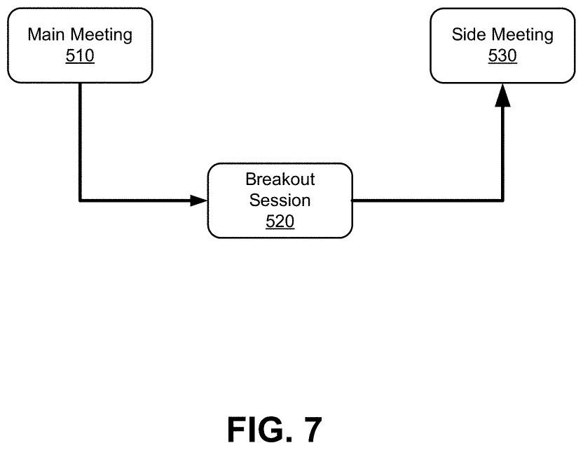

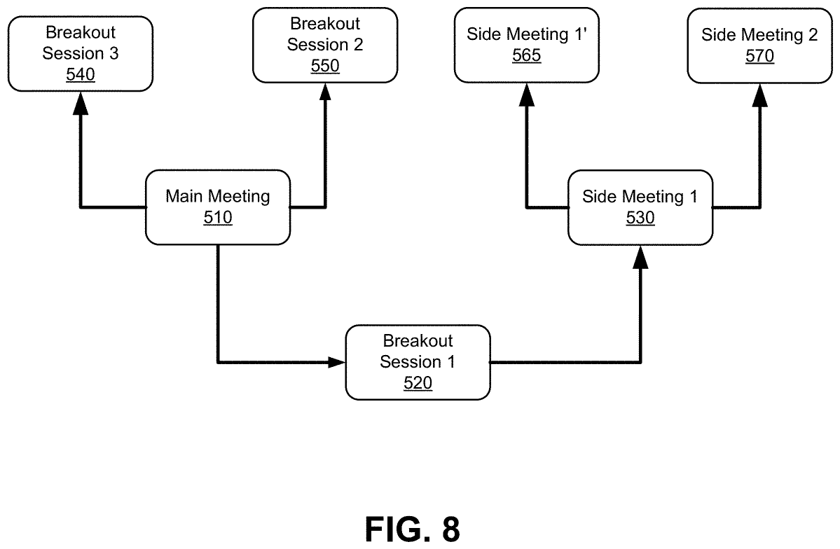

As discussed above, streams can spawn new streams when side sessions are initiated. For example, meeting participants may start a side session with different focus areas and activities. FIG. 5 illustrates a single meeting scenario such as a conference that has started with a main meeting 510. FIG. 6 illustrates a first breakout session 520 giving rise to the need for possibly two streams. FIG. 7 illustrates a first side meeting 520 that has been spawned from breakout session 520 giving rise to the need for possibly three total streams. Additional meetings may continue to be spawned, as illustrated in FIG. 8.

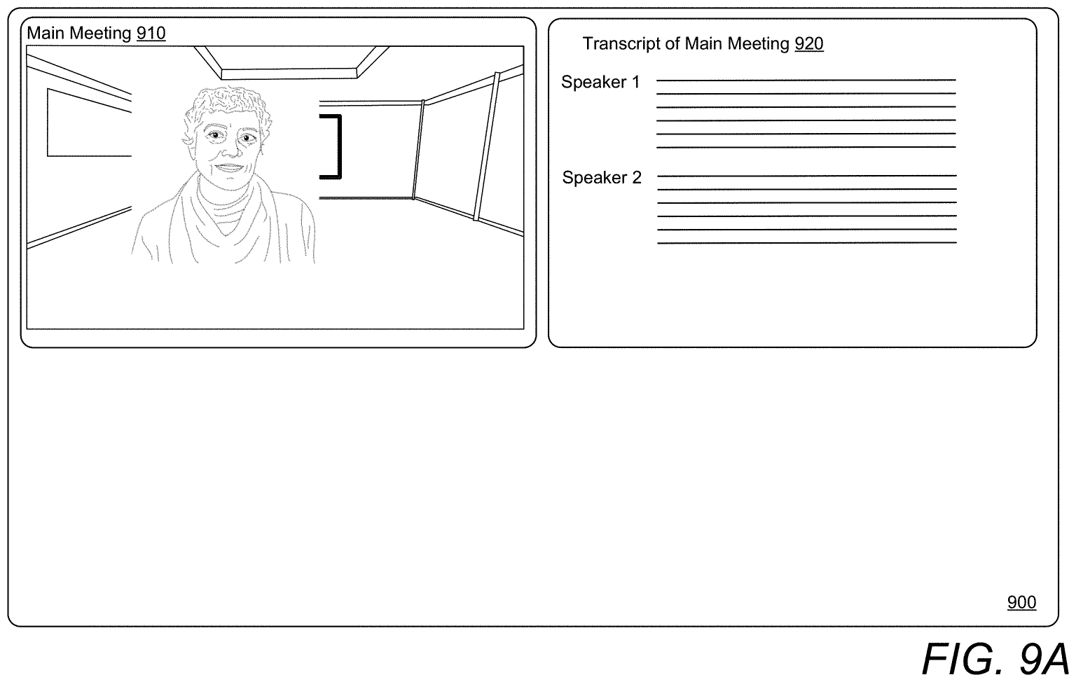

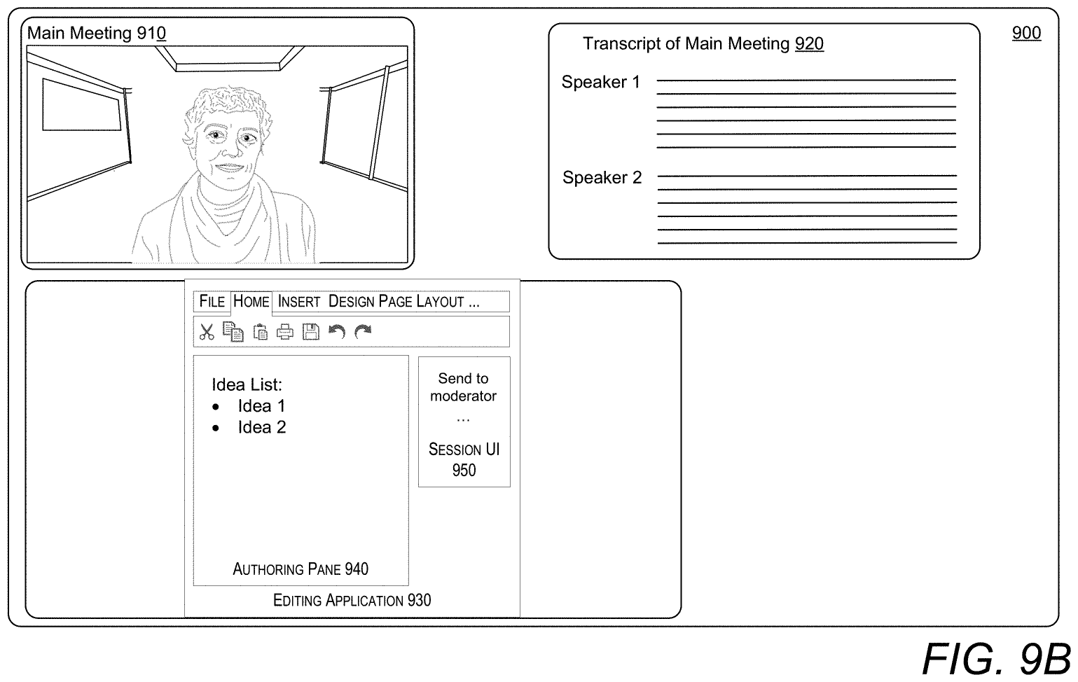

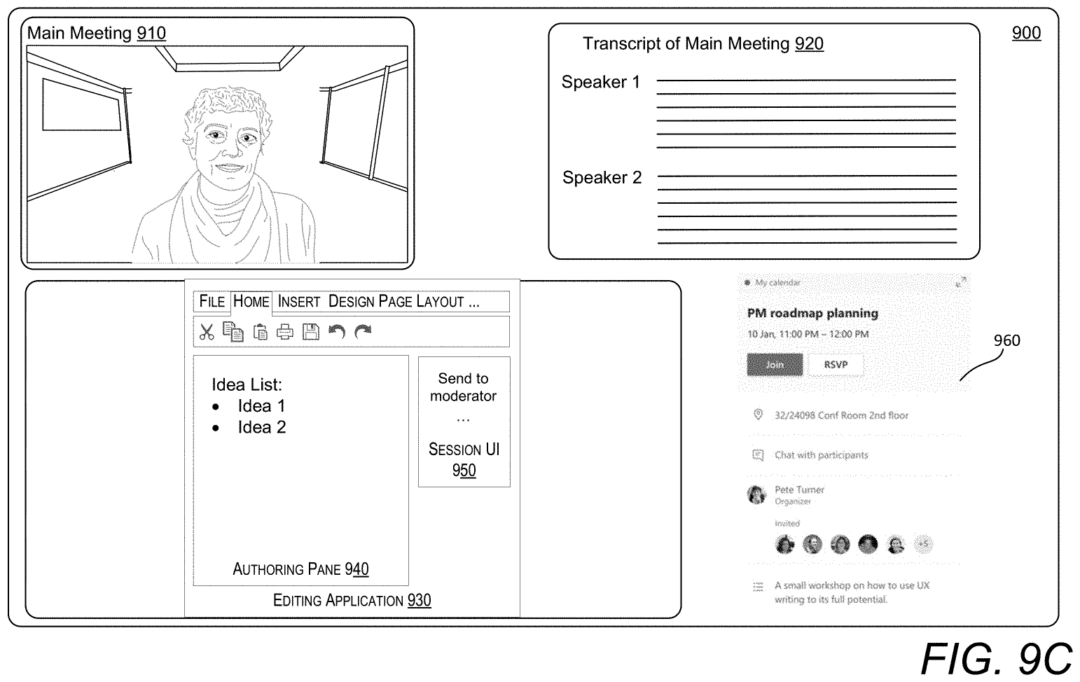

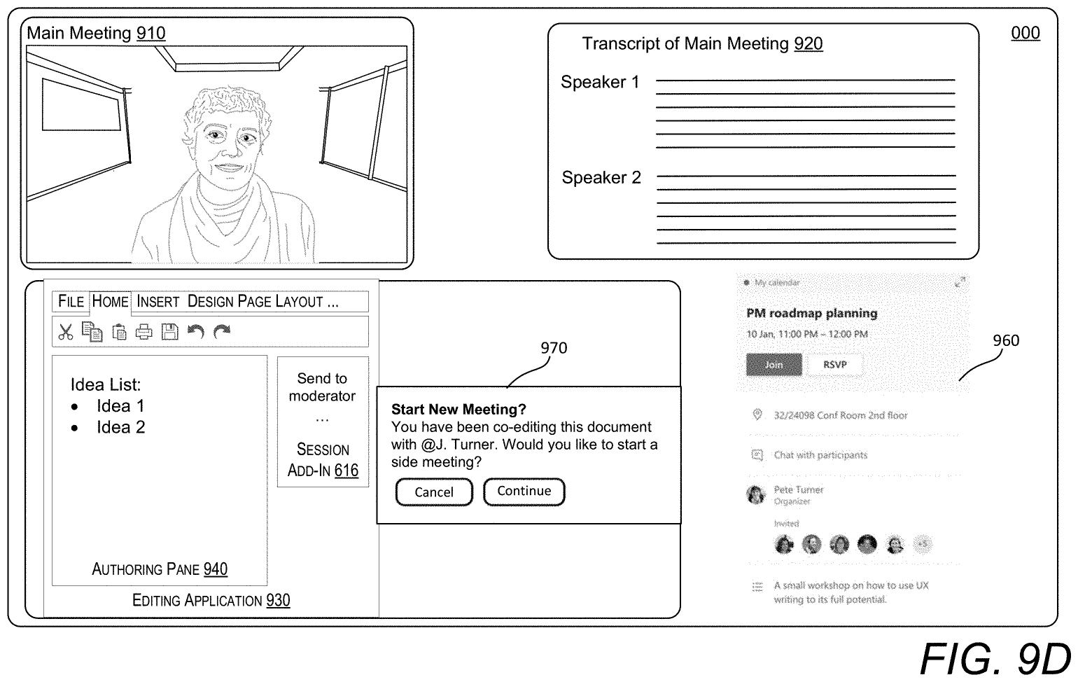

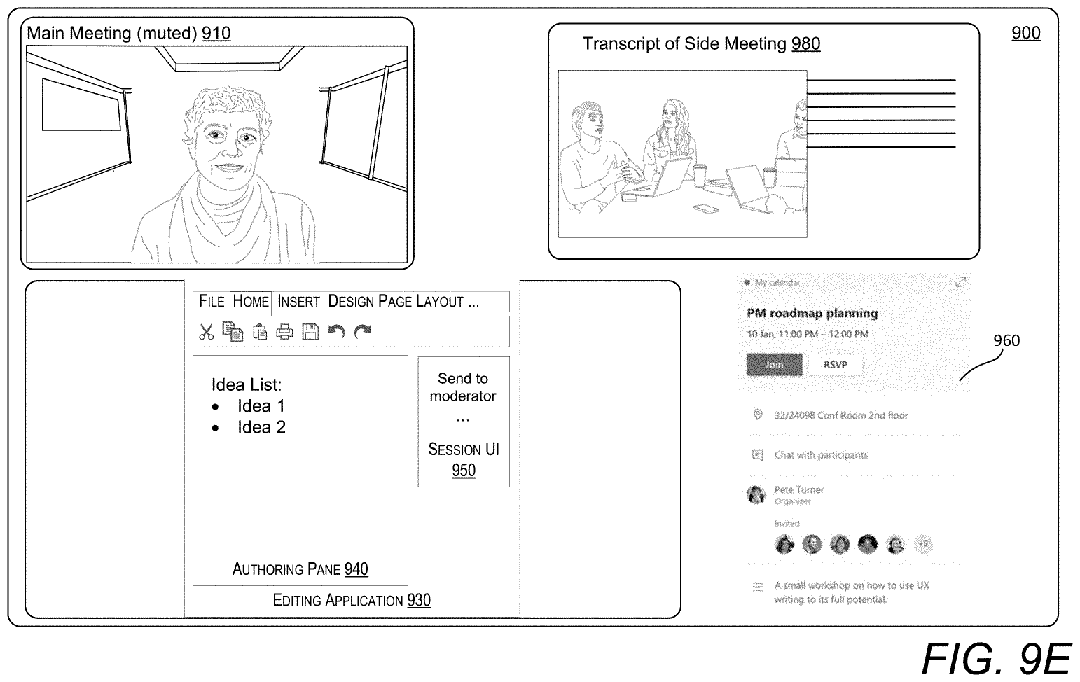

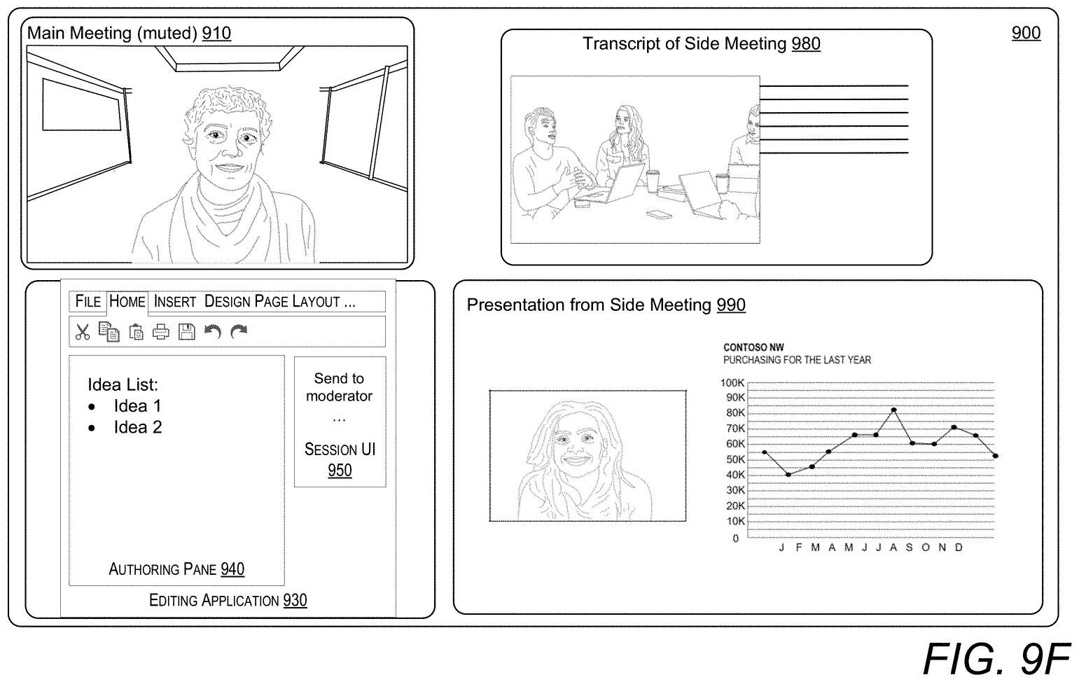

In some embodiments, a participant of a communication session may be able to access multiple streams on the participant's device, enabling the user to follow multiple sessions. In the user interface illustrated in FIG. 9A, a session participant may participate in a primary session 910 and monitor the content of a secondary session 920. For example, the participant may render video and audio for the primary session 910, while monitoring the secondary session 920 using closed captioning or other forms of transcribing. FIG. 9B illustrates that the user may begin an editing session using editing application 930 that may include an authoring pan 940 and a way to send data to the session moderator via a session UI 950. FIG. 9C illustrates that the user may further open additional tasks such as a calendaring function 960 while continuing to participate in a primary session 910 and monitor the content of a secondary session 920. FIG. 9D illustrates that the system may detect that the user has started an editing session. If the system detects that the user is interacting with another use during the editing session, the system may suggest a new meeting 970.

The system may enable participants to engage in multiple session streams at different levels or types of modality, allowing the user to dynamically control levels of engagement and activity for each session. As illustrated in FIG. 9E, the user may mute the main session 910 and initiate participation in a side meeting 980. FIG. 9F illustrates that the user may open additional sessions as the various sessions progress, such as viewing a presentation 990 from the side meeting 980.

These examples are provided for illustrative purposes and are not to be construed as limiting. It can be appreciated that other effects and modifications can be applied to video data and content to enhance user engagement. For instance, other types of data can be displayed and/or modified in response to one or more user actions or detected conditions.

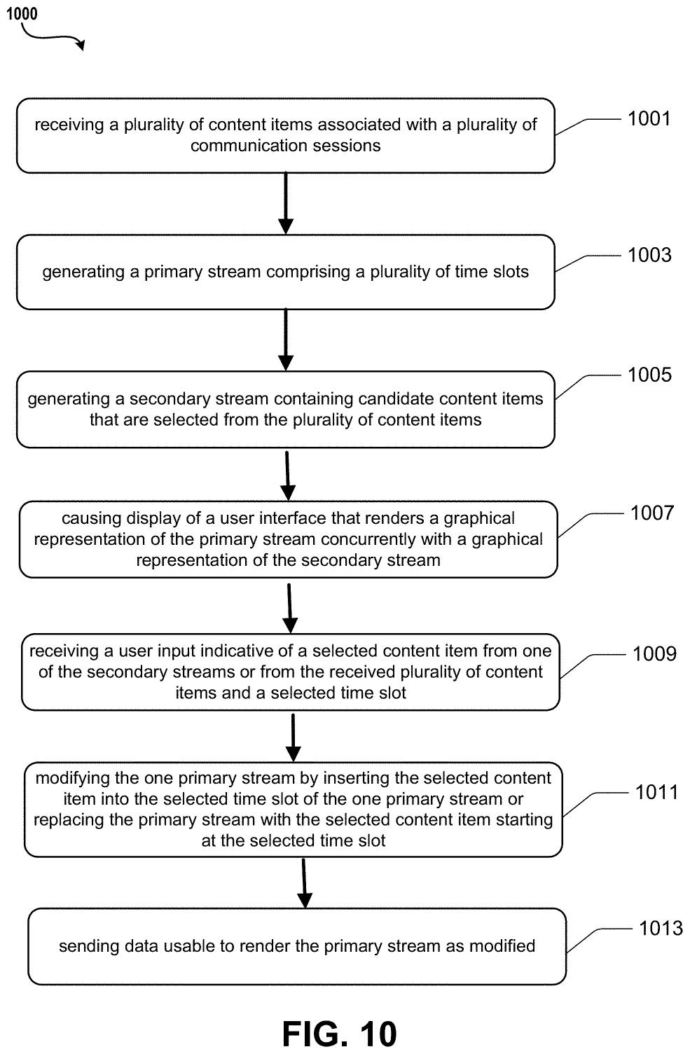

FIG. 10 is a diagram illustrating aspects of a routine 1000 for implementing some of the techniques disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGURES can be implemented in association with the example presentation user interface(s) (UI) described above. For instance, the various device(s) and/or module(s) described herein can generate, transmit, receive, and/or display data associated with content of a communication session (e.g., live content, broadcasted event, recorded content, etc.) and/or a presentation UI that includes renderings of one or more participants of remote computing devices, avatars, channels, chat sessions, video streams, images, virtual objects, and/or applications associated with a communication session.

The routine 1000 begins at operation 1001, which illustrates receiving, at the data processing system, a plurality of content items associated with a plurality of communication sessions.

The routine 1000 then proceeds to operation 1003, which illustrates generating a primary stream for each of the communications sessions, the primary stream comprising a plurality of time slots, wherein content items are associated with the time slots based on user input.

At operation 1005, the data processing system generates a secondary stream for each of the communications sessions, the secondary stream containing candidate content items that are selected from the plurality of content items based on a search of one or more topics associated with the plurality of communications sessions.

Next, at operation 1007, the data processing system causes display of a user interface that renders, on a display, for each of the communications sessions, a graphical representation of the primary stream concurrently with a graphical representation of the secondary stream.

Next, at operation 1009, the data processing system receives a user input indicative of a selected content item from one of the secondary streams or from the received plurality of content items, and a selected time slot in one of the primary streams.

At operation 1011, the data processing system in response to the user input, the one primary stream by inserting the selected content item into the selected time slot of the one primary stream or replacing the primary stream with the selected content item starting at the selected time slot.

At operation 1014, the data processing system sends, to one or more user devices associated with communication sessions associated with the modified primary stream, data usable to render the primary stream as modified and in a primary display area of the one or more user devices, wherein the data is not sent to user devices that are not associated with the modified primary stream.

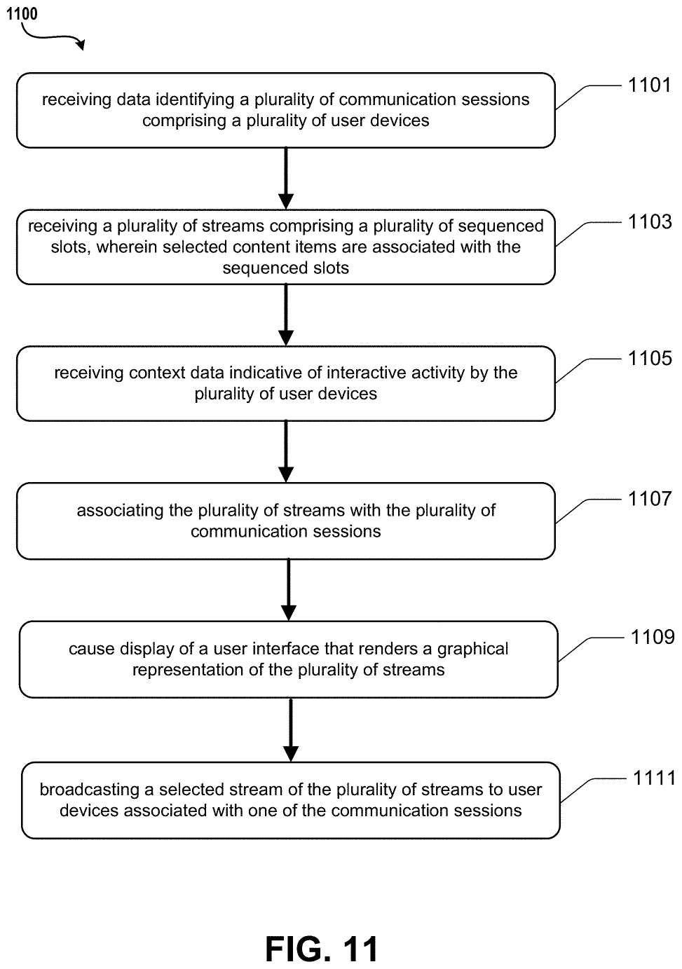

FIG. 11 is a diagram illustrating aspects of a routine 1100 for implementing some of the techniques disclosed herein.

The routine 1100 begins at operation 1101, which illustrates receiving data identifying a plurality of communication sessions comprising a plurality of user devices.

The routine 1100 then proceeds to operation 1103, which illustrates receiving a plurality of streams comprising a plurality of sequenced slots. In an embodiment, selected content items are associated with the sequenced slots.

At operation 1105, the computing device receives context data indicative of interactive activity by the plurality of user devices.

Next, at operation 1107, based on the context data, the computing device associates the plurality of streams with the plurality of communication sessions.

Next, at operation 1109, the computing device cause display of a user interface that renders a graphical representation of the plurality of streams.

At operation 1111, in response to a user input, the computing device broadcasts a selected stream of the plurality of streams to user devices associated with one of the communication sessions. In an embodiment, the selected stream is not sent to user devices that are not associated with the one communication session. In one embodiment, the selected stream is usable to render the selected in a primary display area of the user devices associated with the one communication session.

In some embodiments, the selecting one of the plurality of streams as a suggested stream is performed automatically based on the context data. In some embodiments, the computing device may receive data identifying a second communication session between a second plurality of user devices. The computing device may further receive context data indicative of interactive activity by the second plurality of user devices. Based on the context data for the second plurality of user devices, the computing device may select one of the plurality of streams as a suggested stream for broadcast to the second plurality of user devices, and cause the user interface to render a graphical representation of the suggested stream for broadcast to the second plurality of user devices. The computing device, in response to a user input received via the user interface, may broadcast a selected stream to the second plurality of user devices.

In some embodiments, least one of the content items of the plurality of streams are received from one of the first or second plurality of users. In some embodiments, the computing device may receive data identifying additional communication sessions between additional groups of user devices, and receive context data indicative of interactive activity by the additional groups of user devices. Based on the context data for the additional groups of user devices, the computing device may select one of the plurality of streams as a suggested stream for broadcast to the additional groups of user devices. The computing device may cause the user interface to render a graphical representation of the suggested stream for broadcast to the additional groups of user devices, and in response to a user input received via the user interface, the computing device may broadcast selected streams to the additional groups of user devices.

In some embodiments, at least one of the content items of the plurality of streams may be received from one of the first or second plurality of users. In one embodiment, the computing device may associate the second communication session as a related session of the second communication session, and receive content items from the second communication session as suggested content for the first communication session.

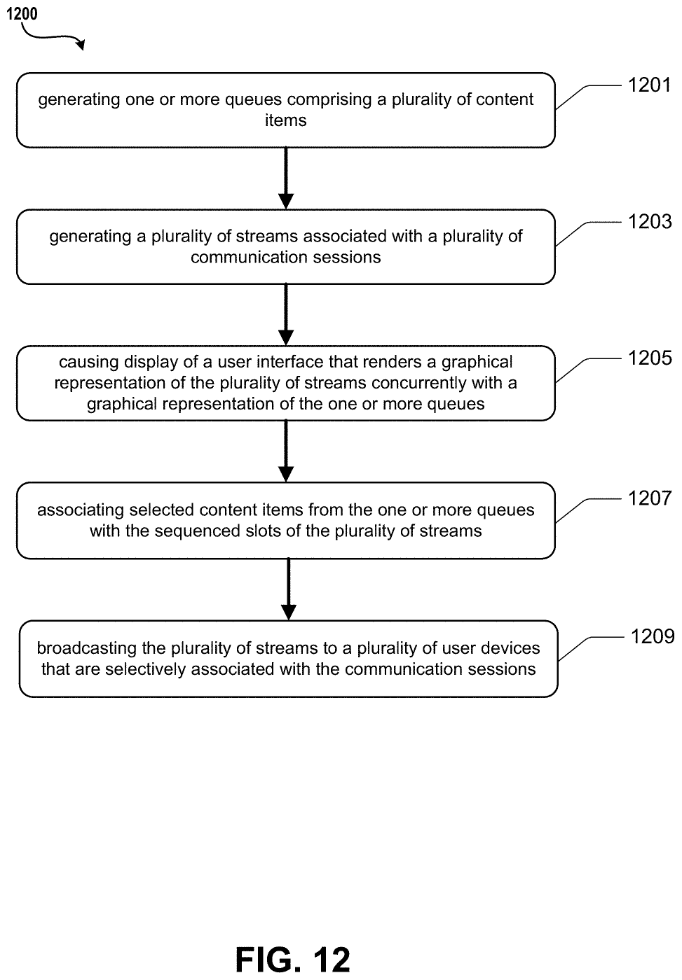

FIG. 12 is a diagram illustrating aspects of a routine 1200 for implementing some of the techniques disclosed herein.

The routine 1200 begins at operation 1201, which illustrates generating one or more queues comprising a plurality of content items.

The routine 1200 then proceeds to operation 1203, which illustrates generating a plurality of streams associated with a plurality of communication sessions, the plurality of streams comprising a plurality of sequenced slots.

At operation 1205, which illustrates causing display of a user interface that renders a graphical representation of the plurality of streams concurrently with a graphical representation of the one or more queues.

Next, operation 1207 illustrates in response to a user input, associating selected content items from the one or more queues with the sequenced slots of the plurality of streams.

Next, operation 1209 illustrates broadcasting the plurality of streams to a plurality of user devices that are selectively associated with the communication sessions. In an embodiment, the streams are rendered in a primary display area of the plurality of user devices. In one embodiment, the plurality of user devices receive streams only for communication session with which they are selectively associated.

In an embodiment, the sequenced slots of the primary stream may be automatically populated based on a current topic associated with the communication session. Additionally and optionally, the content items of the one or more queues may be automatically populated based on a current topic associated with the communication session.

In some embodiments, the content items of the one or more queues may be identified based on a search of content items that is conducted based on one or more topics associated with the primary stream.

In some embodiments, the system may receive data identifying an additional communication session, and generate a secondary stream comprising a plurality of sequenced slots for the additional communication session. The system may render, on the user interface, a graphical representation of the secondary stream concurrently with a graphical representation of the primary stream and the one or more queues. In response to a user input received via the user interface, the system may insert selected content items from the queues into the sequenced slots of the secondary stream, and broadcast the secondary stream to a plurality of user devices of the additional communication session.

In an embodiment, the system may associate the additional communication session as a related session of the communication session, and receive content items from the additional communication session as suggested content for the communication session.

In an embodiment, the system may receive data that the additional communication session has terminated, and store content items from the additional communication session.

In an embodiment, the system may receive suggested content items from the plurality of user devices, and add selected ones of the suggested content items to the one or more queues.

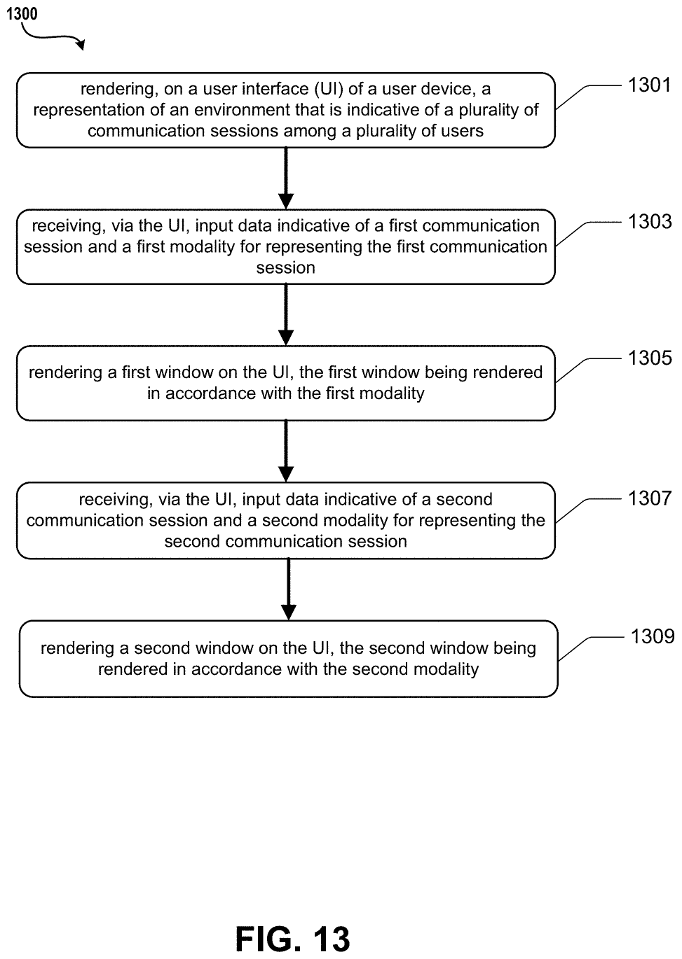

FIG. 13 is a diagram illustrating aspects of a routine 1300 for implementing some of the techniques disclosed herein.

The routine 1300 begins at operation 1301, which illustrates causing, by the data processing system, display of a user interface that renders, on a user interface (UI) of a user device, a representation of a plurality of communication sessions.

The routine 1300 then proceeds to operation 1303, which illustrates receiving, by the data processing system, input data indicative of a first communication session and a first modality for representing the first communication session.

At operation 1305, which illustrates receiving, by the data processing system, input data indicative of a first communication session and a first modality for representing the first communication session.

Next, at operation 1307, the data processing system receives input data indicative of a second communication session and a second modality for representing the second communication session.

Next, at operation 1309, in response to the input data, data processing system causes display of a second window on the UI in accordance with the second modality. In an embodiment, the second window has content based on a second stream associated with the second communication session. In some embodiments, the second stream comprises a plurality of sequenced slots that are associated with content items associated with the second communication session.

In some embodiments, the system may send, to a computing device configured to generate the first and second streams, information indicative of interactions with content of the first or second streams. Additionally, the system may receive, from the computing device, updates to the first or second streams that are based on the information indicative of the interactions.

In an embodiment, the system may send, to a computing device configured to generate the first and second streams, suggested content for the first or second streams. Additionally, the system may receive, via the UI, input data indicative of additional communication sessions and modalities for representing the additional communication sessions, and in response to the input data indicative of the additional communication sessions, the system may render additional windows on the UI. In some embodiments, the additional windows may be rendered in accordance with the modalities for representing the additional communication sessions, and the additional windows may have content based on additional streams comprising a plurality of sequenced slots for the additional communication sessions.

In some embodiments, the system may receive, via the UI, input data indicative of a change in modality for representing the first or second communication session, and in response to the input data indicative of the change in modality, the system may update the rendering of the first or second windows on the UI in accordance with the changed modality.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

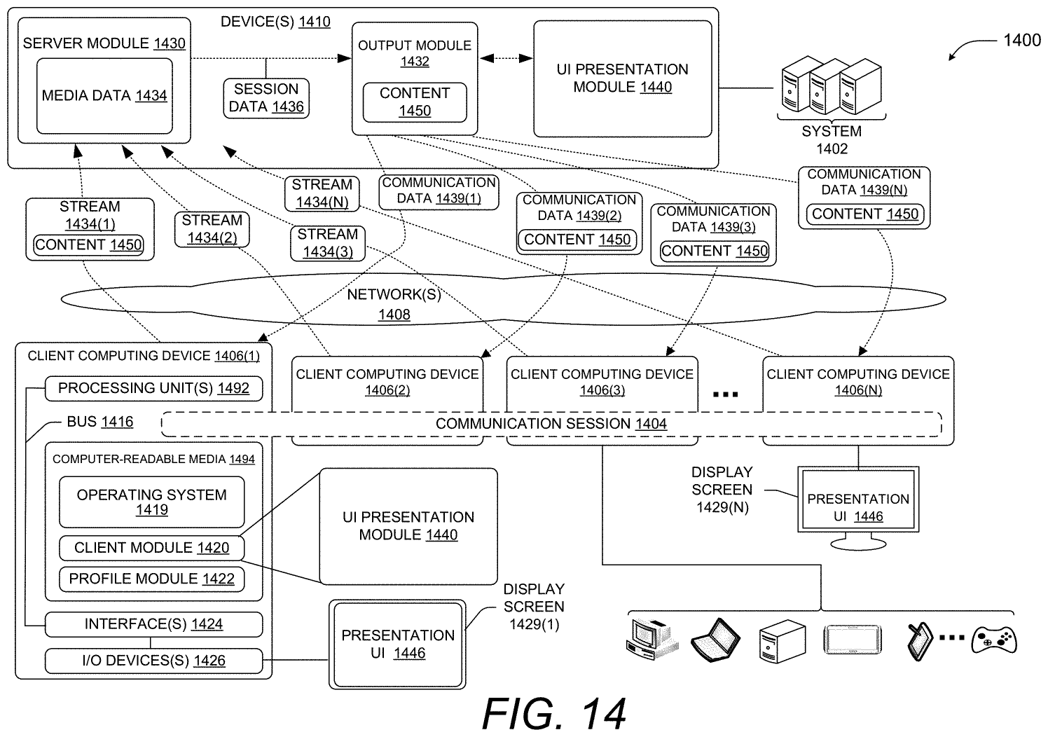

FIG. 14 is a diagram illustrating an example environment 1400 in which a system 1402 (which can be system 100 of FIG. 1) can implement the techniques disclosed herein. In some implementations, a system 1402 may function to collect, analyze, and share data defining one or more objects that are displayed to users of a communication session 1404.

As illustrated, the communication session 1404 may be implemented between a number of client computing devices 1406(1) through 1406(N) (where N is a number having a value of two or greater) that are associated with the system 1402 or are part of the system 1402. The client computing devices 1406(1) through 1406(N) enable users, also referred to as individuals, to participate in the communication session 1404.

In this example, the communication session 1404 is hosted, over one or more network(s) 1408, by the system 1402. That is, the system 1402 can provide a service that enables users of the client computing devices 1406(1) through 1406(N) to participate in the communication session 1404 (e.g., via a live viewing and/or a recorded viewing). Consequently, a “participant” to the communication session 1404 can comprise a user and/or a client computing device (e.g., multiple users may be in a room participating in a communication session via the use of a single client computing device), each of which can communicate with other participants. As an alternative, the communication session 1404 can be hosted by one of the client computing devices 1406(1) through 1406(N) utilizing peer-to-peer technologies. The system 1402 can also host chat conversations and other team collaboration functionality (e.g., as part of an application suite).

In some implementations, such chat conversations and other team collaboration functionality are considered external communication sessions distinct from the communication session 1404. A computerized agent configured to collect participant data in the communication session 1404 may be able to link to such external communication sessions. Therefore, the computerized agent may receive information, such as date, time, session particulars, and the like, that enables connectivity to such external communication sessions. In one example, a chat conversation can be conducted in accordance with the communication session 1404. Additionally, the system 1402 may host the communication session 1404, which includes at least a plurality of participants co-located at a meeting location, such as a meeting room or auditorium, or located in disparate locations.

In examples described herein, client computing devices 1406(1) through 1406(N) participating in the communication session 1404 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that captures the appearance and speech of a user participating in the communication session). In some implementations, the video feeds may comprise such audio and visual data, one or more still images, and/or one or more avatars. The one or more still images may also comprise one or more avatars.

Another example of an individual stream of live and/or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live and/or recorded content within the communication data enable a remote meeting to be facilitated between a group of people and the sharing of content within the group of people. In some implementations, the various streams of live and/or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1404 live as activity occurs, or alternatively, via a recording at a later time after the activity occurs. In examples described herein, client computing devices 1406(1) through 1406(N) participating in the communication session 1404 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee of a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 1402 includes device(s) 1410. The device(s) 1410 and/or other components of the system 1402 can include distributed computing resources that communicate with one another and/or with the client computing devices 1406(1) through 1406(N) via the one or more network(s) 1408. In some examples, the system 1402 may be an independent system that is tasked with managing aspects of one or more communication sessions such as communication session 1404. As an example, the system 1402 may be managed by entities such as SLACK, WEBEX, GOTOMEETING, GOOGLE HANGOUTS, etc.

Network(s) 1408 may include, for example, public networks such as the Internet, private networks such as an institutional and/or personal intranet, or some combination of private and public networks. Network(s) 1408 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1408 may utilize communications protocols, including packet-based and/or datagram-based protocols such as Internet protocol (“IP”), transmission control protocol (“TCP”), user datagram protocol (“UDP”), or other types of protocols. Moreover, network(s) 1408 may also include a number of devices that facilitate network communications and/or form a hardware basis for the networks, such as switches, routers, gateways, access points, firewalls, base stations, repeaters, backbone devices, and the like.

In some examples, network(s) 1408 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.14 standards (e.g., 802.14g, 802.14n, 802.14ac and so forth), and other standards.

In various examples, device(s) 1410 may include one or more computing devices that operate in a cluster or other grouped configuration to share resources, balance load, increase performance, provide fail-over support or redundancy, or for other purposes. For instance, device(s) 1410 may belong to a variety of classes of devices such as traditional server-type devices, desktop computer-type devices, and/or mobile-type devices. Thus, although illustrated as a single type of device or a server-type device, device(s) 1410 may include a diverse variety of device types and are not limited to a particular type of device. Device(s) 1410 may represent, but are not limited to, server computers, desktop computers, web-server computers, personal computers, mobile computers, laptop computers, tablet computers, or any other sort of computing device.

A client computing device (e.g., one of client computing device(s) 1406(1) through 1406(N)) may belong to a variety of classes of devices, which may be the same as, or different from, device(s) 1410, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1406(1) through 1406(N) of the various classes and device types can represent any type of computing device having one or more data processing unit(s) 1492 operably connected to computer-readable media 1494 such as via a bus 1416, which in some instances can include one or more of a system bus, a data bus, an address bus, a PCI bus, a Mini-PCI bus, and any variety of local, peripheral, and/or independent buses.

Executable instructions stored on computer-readable media 1494 may include, for example, an operating system 1419, a client module 1420, a profile module 1422, and other modules, programs, or applications that are loadable and executable by data processing units(s) 1492.

Client computing device(s) 1406(1) through 1406(N) may also include one or more interface(s) 1424 to enable communications between client computing device(s) 1406(1) through 1406(N) and other networked devices, such as device(s) 1410, over network(s) 1408. Such network interface(s) 1424 may include one or more network interface controllers (NICs) or other types of transceiver devices to send and receive communications and/or data over a network. Moreover, client computing device(s) 1406(1) through 1406(N) can include input/output (“I/O”) interfaces (devices) 1426 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 14 illustrates that client computing device 1406(1) is in some way connected to a display device (e.g., a display screen 1429(1)), which can display a UI according to the techniques described herein.

In the example environment 1400 of FIG. 14, client computing devices 1406(1) through 1406(N) may use their respective client modules 1420 to connect with one another and/or other external device(s) in order to participate in the communication session 1404, or in order to contribute activity to a collaboration environment. For instance, a first user may utilize a client computing device 1406(1) to communicate with a second user of another client computing device 1406(2). When executing client modules 1420, the users may share data, which may cause the client computing device 1406(1) to connect to the system 1402 and/or the other client computing devices 1406(2) through 1406(N) over the network(s) 1408.

The client computing device(s) 1406(1) through 1406(N) may use their respective profile modules 1422 to generate participant profiles (not shown in FIG. 14) and provide the participant profiles to other client computing devices and/or to the device(s) 1410 of the system 1402. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 14, the device(s) 1410 of the system 1402 include a server module 1430 and an output module 1432. In this example, the server module 1430 is configured to receive, from individual client computing devices such as client computing devices 1406(1) through 1406(N), media streams 1434(1) through 1434(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1430 is configured to receive a collection of various media streams 1434(1) through 1434(N) during a live viewing of the communication session 1404 (the collection being referred to herein as “media data 1434”). In some scenarios, not all of the client computing devices that participate in the communication session 1404 provide a media stream. For example, a client computing device may only be a consuming, or a “listening”, device such that it only receives content associated with the communication session 1404 but does not provide any content to the communication session 1404.

In various examples, the server module 1430 can select aspects of the media streams 1434 that are to be shared with individual ones of the participating client computing devices 1406(1) through 1406(N). Consequently, the server module 1430 may be configured to generate session data 1436 based on the streams 1434 and/or pass the session data 1436 to the output module 1432. Then, the output module 1432 may communicate communication data 1439 to the client computing devices (e.g., client computing devices 1406(1) through 1406(N) participating in a live viewing of the communication session). The communication data 1439 may include video, audio, and/or other content data, provided by the output module 1432 based on content 1450 associated with the output module 1432 and based on received session data 1436.

As shown, the output module 1432 transmits communication data 1439(1) to client computing device 1406(1), and transmits communication data 1439(2) to client computing device 1406(2), and transmits communication data 1439(3) to client computing device 1406(3), etc. The communication data 1439 transmitted to the client computing devices can be the same or can be different (e.g., positioning of streams of content within a user interface may vary from one device to the next).

In various implementations, the device(s) 1410 and/or the client module 1420 can include GUI presentation module 1440. The GUI presentation module 1440 may be configured to analyze communication data 1439 that is for delivery to one or more of the client computing devices 1406. Specifically, the UI presentation module 1440, at the device(s) 1410 and/or the client computing device 1406, may analyze communication data 1439 to determine an appropriate manner for displaying video, image, and/or content on the display screen 1429 of an associated client computing device 1406. In some implementations, the GUI presentation module 1440 may provide video, images, and/or content to a presentation GUI 1446 rendered on the display screen 1429 of the associated client computing device 1406. The presentation GUI 1446 may be caused to be rendered on the display screen 1429 by the GUI presentation module 1440. The presentation GUI 1446 may include the video, images, and/or content analyzed by the GUI presentation module 1440.

In some implementations, the presentation GUI 1446 may include a plurality of sections or grids that may render or comprise video, image, and/or content for display on the display screen 1429. For example, a first section of the presentation GUI 1446 may include a video feed of a presenter or individual, and a second section of the presentation GUI 1446 may include a video feed of an individual consuming meeting information provided by the presenter or individual. The GUI presentation module 1440 may populate the first and second sections of the presentation GUI 1446 in a manner that properly imitates an environment experience that the presenter and the individual may be sharing.

In some implementations, the GUI presentation module 1440 may enlarge or provide a zoomed view of the individual represented by the video feed in order to highlight a reaction, such as a facial feature, the individual had to the presenter. In some implementations, the presentation GUI 1446 may include a video feed of a plurality of participants associated with a meeting, such as a general communication session. In other implementations, the presentation GUI 1446 may be associated with a channel, such as a chat channel, enterprise teams channel, or the like. Therefore, the presentation GUI 1446 may be associated with an external communication session that is different than the general communication session.

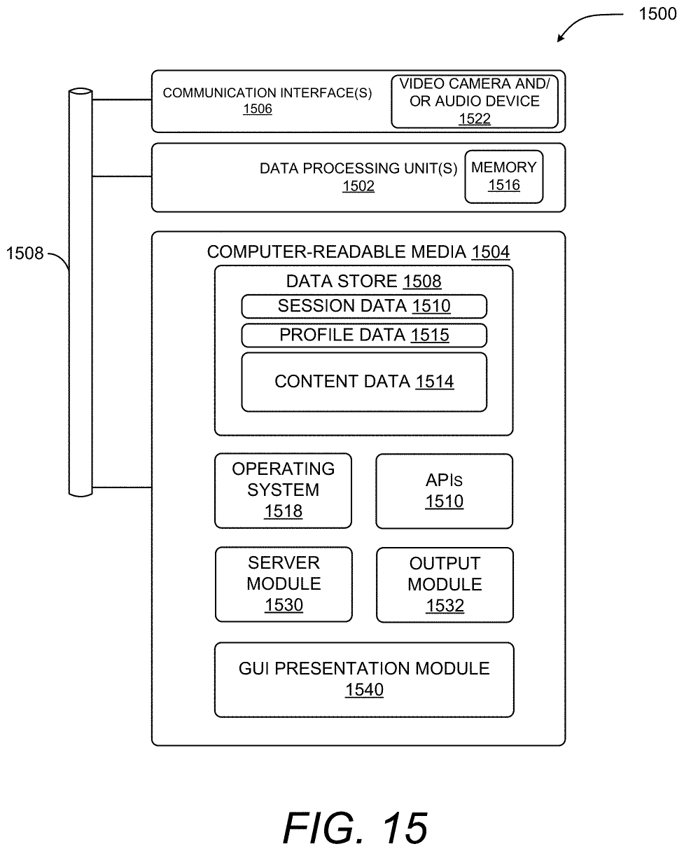

FIG. 15 illustrates a diagram that shows example components of an example device 1500 (also referred to herein as a “computing device”) configured to generate and process data for some of the user interfaces disclosed herein. The device 1500 may generate data that may include one or more sections that may render or comprise video, images, and/or content for display on the display screen 1159. The device 1500 may represent one of the device(s) described herein. Additionally, or alternatively, the device 1500 may represent one of the client computing devices 1106.

As illustrated, the device 1500 includes one or more data processing unit(s) 1502, computer-readable media 1504, and communication interface(s) 1506. The components of the device 1500 are operatively connected, for example, via a bus 1509, which may include one or more of a system bus, a data bus, an address bus, a PCI bus, a Mini-PCI bus, and any variety of local, peripheral, and/or independent buses.

As utilized herein, data processing unit(s), such as the data processing unit(s) 1502 and/or data processing unit(s) 1192, may represent, for example, a CPU-type data processing unit, a GPU-type data processing unit, a field-programmable gate array (“FPGA”), another class of digital signal processors (“DSPs”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1504 and computer-readable media 1194, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1506 may represent, for example, network interface controllers (“NICs”) or other types of transceiver devices to send and receive communications over a network. Furthermore, the communication interface(s) 1506 may include one or more video cameras and/or audio devices 1522 to enable generation of video feeds and/or still images, and so forth.

In the illustrated example, computer-readable media 1504 includes a data store 1508. In some examples, the data store 1508 includes data storage such as a database, data warehouse, or other type of structured or unstructured data storage. In some examples, the data store 1508 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1508 may store data for the operations of processes, applications, components, and/or modules stored in computer-readable media 1504 and/or executed by data processing unit(s) 1502 and/or accelerator(s). For instance, in some examples, the data store 1508 may store session data 1510, profile data 1515 (e.g., associated with a participant profile), and/or other data. The session data 1510 can include a total number of participants (e.g., users and/or client computing devices) in a communication session, activity that occurs in the communication session, a list of invitees to the communication session, and/or other data related to when and how the communication session is conducted or hosted. The data store 1508 may also include content data 1514, such as the content that includes video, audio, or other content for rendering and display on one or more of the display screens 1159.

Alternately, some or all of the above-referenced data can be stored on separate memories 1516 on board one or more data processing unit(s) 1502 such as a memory on board a CPU-type processor, a GPU-type processor, an FPGA-type accelerator, a DSP-type accelerator, and/or another accelerator. In this example, the computer-readable media 1504 also includes an operating system 1518 and application programming interface(s) 1510 (APIs) configured to expose the functionality and the data of the device 1500 to other devices. Additionally, the computer-readable media 1504 includes one or more modules such as the server module 1530, the output module 1532, and the GUI presentation module 1540, although the number of illustrated modules is just an example, and the number may vary higher or lower. That is, functionality described herein in association with the illustrated modules may be performed by a fewer number of modules or a larger number of modules on one device or spread across multiple devices.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

### EXAMPLE CLAUSES

The disclosure presented herein may be considered in view of the following clauses.

Example Clause A, a method performed by a data processing system, the method comprising:

receiving, at the data processing system, a plurality of content items associated with a plurality of communication sessions;

generating a primary stream for each of the communications sessions, the primary stream comprising a plurality of time slots, wherein content items are associated with the time slots based on user input;

generating a secondary stream for each of the communications sessions, the secondary stream containing candidate content items that are selected from the plurality of content items based on a search of one or more topics associated with the plurality of communications sessions;

causing display of a user interface that renders, on a display, for each of the communications sessions, a graphical representation of the primary stream concurrently with a graphical representation of the secondary stream;

receiving a user input indicative of a selected content item from one of the secondary streams or from the received plurality of content items, and a selected time slot in one of the primary streams;

in response to the user input, modifying the one primary stream by inserting the selected content item into the selected time slot of the one primary stream or replacing the primary stream with the selected content item starting at the selected time slot; and

sending, by the data processing system to one or more user devices associated with communication sessions associated with the modified primary stream, data usable to render the primary stream as modified and in a primary display area of the one or more user devices, wherein the data is not sent to user devices that are not associated with the modified primary stream.

Example Clause B, the method of Example Clause A, wherein the candidate content items are identified based on a search of content items in one or more content queues.

Example Clause C, the method of Example Clause B, wherein the candidate content items are identified based on a search of content items in one or more queues associated with the plurality of communication sessions.

Example Clause D, the method of any one of Example Clauses A through C, wherein the candidate content items are identified based on a search of content items that is conducted based on one or more topics associated with the plurality of communication sessions.

Example Clause E, the method of any one of Example Clauses A through D, wherein the candidate content items are identified based on a search of content that is external to the plurality of communication sessions.

While Example Clauses A through E are described above with respect to a method, it is understood in the context of this disclosure that the subject matter of Example Clauses A through E can additionally or alternatively be implemented as a system, computing device, or via computer readable storage media.

Example Clause F, a computing device, comprising:

one or more data processing units; and

a computer-readable medium having encoded thereon computer-executable instructions to cause the one or more data processing units to perform operations comprising:

receiving data identifying a plurality of communication sessions comprising a plurality of user devices;

receiving a plurality of streams comprising a plurality of sequenced slots, wherein selected content items are associated with the sequenced slots;

receiving context data indicative of interactive activity by the plurality of user devices;

based on the context data, associating the plurality of streams with the plurality of communication sessions;

causing display of a user interface that renders a graphical representation of the plurality of streams; and

in response to a user input, broadcasting a selected stream of the plurality of streams to user devices associated with one of the communication sessions, wherein the selected stream is not sent to user devices that are not associated with the one communication session, and wherein the selected stream is usable to render the selected in a primary display area of the user devices associated with the one communication session.

Example Clause G, the computing device of Example Clause F, wherein the associating the plurality of streams with the plurality of communication sessions is performed automatically based on the context data.

Example Clause H, the computing device of Example Clause F or Example Clause G, further comprising computer-executable instructions to cause the one or more data processing units to perform operations comprising:

in response to a second user input, broadcasting a second selected stream to a second plurality of user devices associated with a second communication session

Example Clause I, the computing device of Example Clauses F through Example Clause H, wherein at least one of the content items of the plurality of streams are received from one of the plurality of user devices.

Example Clause J, the computing device of Example Clauses F through Example Clause I, further comprising computer-executable instructions to cause the one or more data processing units to perform operations comprising:

receiving data identifying additional communication sessions between additional groups of user devices;

receiving context data indicative of interactive activity by the additional groups of user devices;

based on the context data for the additional groups of user devices, selecting one of the plurality of streams as a suggested stream for broadcast to the additional groups of user devices;

cause display of a graphical representation of the suggested stream for broadcast to the additional groups of user devices; and

in response to a further user input, broadcasting selected streams to the additional groups of user devices.

Example Clause K, the computing device of Example Clauses F through Example Clause J, wherein at least one of the content items of the plurality of streams are received from one of the first or second plurality of user devices.

Example Clause L, the computing device of Example Clauses F through Example Clause K, further comprising computer-executable instructions to cause the one or more data processing units to perform operations comprising:

associating the second communication session as a related session of the first communication session; and

receiving content items from the second communication session as suggested content for the first communication session.

While Example Clauses F through L are described above with respect to a computing device, it is understood in the context of this disclosure that the subject matter of Example Clauses F through L can additionally or alternatively be implemented by a method, system, or via computer readable storage media.

Example Clause M, a system, comprising:

means for generating one or more queues comprising a plurality of content items;

means for generating a plurality of streams associated with a plurality of communication sessions, the plurality of streams comprising a plurality of sequenced slots;

means for causing display of a user interface that renders a graphical representation of the plurality of streams concurrently with a graphical representation of the one or more queues;

means for, in response to a user input, associating selected content items from the one or more queues with the sequenced slots of the plurality of streams; and

means for broadcasting the plurality of streams to a plurality of user devices that are selectively associated with the communication sessions, wherein the streams are rendered in a primary display area of the plurality of user devices, and wherein the plurality of user devices receive streams only for communication session with which they are selectively associated.

Example Clause N, the system of Example Clause M, wherein the sequenced slots are automatically populated based on one or more topics associated with the communication session.

Example Clause O, the system of Example Clause M or N, wherein the content items of the one or more queues are automatically populated based on a current topic associated with the plurality of communication sessions.

Example Clause P, the system of Example Clauses M through Example Clause O, wherein the content items of the one or more queues are identified based on a search that is conducted based on one or more topics associated with the plurality of communication sessions.

Example Clause Q, the system of Example Clauses M through Example Clause P, further comprising:

means for receiving data identifying newly added communication sessions;

means for generating additional streams comprising a plurality of sequenced slots for the newly added communication sessions;

means for causing display of a user interface that renders a graphical representation of the additional streams concurrently with a graphical representation of the plurality of streams and the one or more queues;

means for, in response to a further user input, inserting additional selected content items from the one or more queues into the sequenced slots of the additional streams; and means for broadcasting the additional streams to user devices associated with the newly added communication sessions.

Example Clause R, the system of Example Clauses M through Example Clause Q, further comprising:

means for associating the newly added communication sessions as related sessions of one or more current communication sessions; and

means for receiving content items from the newly added communication sessions as suggested content for the one or more current communication sessions.

Example Clause S, the system of Example Clauses M through Example Clause R, further comprising:

means for receiving data that a communication session has terminated; and

means for storing content items from the terminated communication session.

Example Clause T, the system of Example Clauses M through Example Clause S, further comprising:

means for receiving suggested content items from the plurality of user devices; and

means for adding selected ones of the suggested content items to the one or more queues.

While Example Clauses M through T are described above with respect to a system, it is understood in the context of this disclosure that the subject matter of Example Clauses M through T can additionally or alternatively be implemented as a method, computer readable medium, or computing device.

Example Clause U, a method to be performed by a data processing system, the method comprising:

causing, by the data processing system, display of a user interface that renders, on a user interface (UI) of a user device, a representation of a plurality of communication sessions;

receiving, by the data processing system, input data indicative of a first communication session and a first modality for representing the first communication session;

receiving, by the data processing system, input data indicative of a first communication session and a first modality for representing the first communication session;

receiving input data indicative of a second communication session and a second modality for representing the second communication session; and

in response to the input data, causing display of a second window on the UI in accordance with the second modality, the second window having content based on a second stream associated with the second communication session, the second stream comprising a plurality of sequenced slots that are associated with content items associated with the second communication session.

Example Clause V, the method of Example Clause U, further comprising sending, to a computing device configured to generate the first and second streams, information indicative of interactions with content of the first or second streams.

Example Clause W, the method of Example Clause U or Example Clause V, further comprising receiving, from the computing device, updates to the first or second streams that are based on the information indicative of the interactions.

Example Clause X, the method of Example Clauses U through Example Clause W, further comprising sending, to a computing device configured to generate the first and second streams, suggested content for the first or second streams.

Example Clause Y, the method of Example Clauses U through Example Clause X, further comprising:

receiving input data indicative of additional communication sessions and modalities for representing the additional communication sessions; and

in response to the input data, causing display of additional windows on the UI, the additional windows being rendered in accordance with the modalities for representing the additional communication sessions, the additional windows having content based on additional streams comprising a plurality of sequenced slots for the additional communication sessions.

Example Clause Z, the method of Example Clauses U through Example Clause Y, further comprising:

receiving input data indicative of a change in modality for representing the first or second communication session; and

in response to the input data indicative of the change in modality, updating the rendering of the first or second windows on the UI in accordance with the changed modality

What is claimed is:

1. A method performed by a data processing system, the method comprising:
receiving, at the data processing system, a plurality of content items associated with a plurality of communication sessions;
generating a primary stream for each of the communications sessions, the primary stream comprising a plurality of time slots, wherein content items are associated with the time slots based on user input;
generating a secondary stream for each of the communications sessions, the secondary stream containing candidate content items that are selected from the plurality of content items based on a search of one or more topics associated with the plurality of communications sessions;
causing display of a user interface that renders, on a display, for each of the communications sessions, a graphical representation of the primary stream concurrently with a graphical representation of the secondary stream;
receiving a user input indicative of a selected content item from one of the secondary streams or from the received plurality of content items, and a selected time slot in one of the primary streams;
in response to the user input, modifying the one primary stream by inserting the selected content item into the selected time slot of the one primary stream or replacing the primary stream with the selected content item starting at the selected time slot; and
sending, by the data processing system to one or more user devices associated with communication sessions associated with the modified primary stream, data usable to render the primary stream as modified and in a primary display area of the one or more user devices, wherein the data is not sent to user devices that are not associated with the modified primary stream.

2. The method of claim 1, wherein the candidate content items are identified based on a search of content items in one or more content queues.

3. The method of claim 1, wherein the candidate content items are identified based on a search of content items in one or more queues associated with the plurality of communication sessions.

4. The method of claim 1, wherein the candidate content items are identified based on a search of content items that is conducted based on one or more topics associated with the plurality of communication sessions.

5. The method of claim 1, wherein the candidate content items are identified based on a search of content that is external to the plurality of communication sessions.

6. A computing device, comprising:
one or more data processing units; and
a computer-readable medium having encoded thereon computer-executable instructions to cause the one or more data processing units to perform operations comprising:
receiving data identifying a plurality of communication sessions comprising a plurality of user devices;
receiving a plurality of streams comprising a plurality of sequenced slots, wherein selected content items are associated with the sequenced slots;
receiving context data indicative of interactive activity by the plurality of user devices;
based on the context data, associating the plurality of streams with the plurality of communication sessions;
causing display of a user interface that renders a graphical representation of the plurality of streams; and
in response to a user input, broadcasting a selected stream of the plurality of streams to user devices associated with one of the communication sessions, wherein the selected stream is not sent to user devices that are not associated with the one communication session, and wherein the selected stream is usable to render the selected in a primary display area of the user devices associated with the one communication session.

7. The computing device of claim 6, wherein the associating the plurality of streams with the plurality of communication sessions is performed automatically based on the context data.

8. The computing device of claim 6, further comprising computer-executable instructions to cause the one or more data processing units to perform operations comprising:
in response to a second user input, broadcasting a second selected stream to a second plurality of user devices associated with a second communication session.

9. The computing device of claim 8, wherein at least one of the content items of the plurality of streams are received from one of the plurality of user devices.

10. The computing device of claim 8, further comprising computer-executable instructions to cause the one or more data processing units to perform operations comprising:
receiving data identifying additional communication sessions between additional groups of user devices;
receiving context data indicative of interactive activity by the additional groups of user devices;
based on the context data for the additional groups of user devices, selecting one of the plurality of streams as a suggested stream for broadcast to the additional groups of user devices;
cause display of a graphical representation of the suggested stream for broadcast to the additional groups of user devices; and
in response to a further user input, broadcasting selected streams to the additional groups of user devices.

11. The computing device of claim 8, wherein at least one of the content items of the plurality of streams are received from one of the first or second plurality of user devices.

12. The computing device of claim 8, further comprising computer-executable instructions to cause the one or more data processing units to perform operations comprising:
associating the second communication session as a related session of the first communication session; and
receiving content items from the second communication session as suggested content for the first communication session.

13. A system, comprising:
means for generating one or more queues comprising a plurality of content items;
means for generating a plurality of streams associated with a plurality of communication sessions, the plurality of streams comprising a plurality of sequenced slots;
means for causing display of a user interface that renders a graphical representation of the plurality of streams concurrently with a graphical representation of the one or more queues;
means for, in response to a user input, associating selected content items from the one or more queues with the sequenced slots of the plurality of streams; and
means for broadcasting the plurality of streams to a plurality of user devices that are selectively associated with the communication sessions, wherein the streams are rendered in a primary display area of the plurality of user devices, and wherein the plurality of user devices receive streams only for communication session with which they are selectively associated.

14. The system of claim 13, wherein the sequenced slots are automatically populated based on one or more topics associated with the communication session.

15. The system of claim 13, wherein the content items of the one or more queues are automatically populated based on a current topic associated with the plurality of communication sessions.

16. The system of claim 13, wherein the content items of the one or more queues are identified based on a search that is conducted based on one or more topics associated with the plurality of communication sessions.

17. The system of claim 13, further comprising:
means for receiving data identifying newly added communication sessions;
means for generating additional streams comprising a plurality of sequenced slots for the newly added communication sessions;
means for causing display of a user interface that renders a graphical representation of the additional streams concurrently with a graphical representation of the plurality of streams and the one or more queues;
means for, in response to a further user input, inserting additional selected content items from the one or more queues into the sequenced slots of the additional streams; and
means for broadcasting the additional streams to user devices associated with the newly added communication sessions.

18. The system of claim 17, further comprising:
means for associating the newly added communication sessions as related sessions of one or more current communication sessions; and
means for receiving content items from the newly added communication sessions as suggested content for the one or more current communication sessions.

19. The system of claim 17, further comprising:
means for receiving data that a communication session has terminated; and
means for storing content items from the terminated communication session.

20. The system of claim 13, further comprising:
means for receiving suggested content items from the plurality of user devices; and
means for adding selected ones of the suggested content items to the one or more queues.
